(19) United States
(12) Patent Application Publication
(10) Pub. No.: US 2015/0263366 A1
(43) Pub. Date: Sep. 17, 2015

(54) PAPER-STRUCTURED CATALYST, PAPER-STRUCTURED CATALYST ARRAY BODY, AND SOLID OXIDE FUEL CELL PROVIDED WITH PAPER-STRUCTURED CATALYST OR PAPER-STRUCTURED CATALYST ARRAY BODY

(71) Applicant: Kyushu University, National University Corporation, Fukuoka (JP)

(72) Inventors: Yusuke Shiratori, Fukuoka (JP); Tran Quang-Tuyen, Fukuoka (JP); Takuya Kitaoka, Fukuoka (JP); Kazunari Sasaki, Fukuoka (JP); Teppei Ogura, Fukuoka (JP)

(73) Assignee: Kyushu University, National University Corporation, Fukuoka (JP)

(21) Appl. No.: 14/418,586

(22) PCT Filed: Jul. 31, 2013
(86) PCT No.: PCT/JP2013/070767

§ 371 Date: Jan. 30, 2015

(30) Foreign Application Priority Data
Aug. 1, 2012 (JP) 2012-171248

(51) Int. Cl. H01M 8/06; H01M 4/90; C01B 3/40

(52) U.S. Cl. CPC H01M 8/0637; C01B 3/40; H01M 4/9075; H01M 4/9041; C01B 2203/1005; C01B 2203/1082; C01B 2203/1058; C01B 2203/0233; C01B 2203/1235; C01B 2203/84; H01M 2008/1293

(57) ABSTRACT

This invention provides a paper-structured catalyst which exhibits high catalytic activity for hydrocarbon reforming to increase the efficiency of hydrocarbon reforming, and is tolerant to thermal shock to cause destruction of the catalyst structure and clogging and destruction of catalyst voids, and an internal reforming solid oxide fuel cell with the paper-structured catalyst. The paper-structured catalyst according to the present invention is composed of a paper-structured porous support prepared by forming inorganic fibers in a paper-like shape and catalyst metal which is loaded dispersedly on a surface of the paper-structured porous support and has reforming activity against hydrocarbons. The inorganic fibers constituting the paper-structured porous support contain at least partially ion conductive oxide fibers. The reforming activity of the paper structured catalyst against hydrocarbons is high, and the catalyst is tolerant to thermal stress fracture and can easily be formed into a desired size and shape, and the degree of freedom for making catalyst array is high. Since an internal reforming solid oxide fuel cell with the paper-structured catalyst according to the present invention as a hydrocarbon reforming catalyst can suppress thermal stress fracture, and degradation due to carbon deposition, resulting in more stable power generation.

### TECHNICAL FIELD

The present invention relates to a paper-structured catalyst and a paper-structured catalyst array body for reforming hydrocarbons, and an internal reforming solid oxide fuel cell in which hydrocarbons are used as fuel gas.

### BACKGROUND ART

In recent years, a solid oxide fuel cell (SOFC) which exhibits high energy conversion efficiency has been attracting attention as a next-generation energy supply system.

In the SOFC, an ion conductive solid electrolyte is used for an electrolyte membrane, and the SOFC is constituted by joining an anode (fuel electrode) including a porous sintered body and a cathode (air electrode) to one face and the other face of the electrolyte membrane, respectively. When hydrogen as fuel and air (oxygen) are supplied to the anode and the cathode, respectively, it is possible to take out electric energy by the following electrochemical reaction.

Anode reaction: 2H₂+2O²⁻→2H₂O+4^{e-} (Reaction 1)

Cathode reaction: O₂+4^{e-}→2O²⁻ (Reaction 2)

Total reaction: 2H₂+O₂→2H₂O

In the SOFC, a gas obtained by reforming a gas containing hydrocarbons, such as city gas, a propane gas, biogas or a coal gasification gas, as well as hydrogen, can be used as fuel gas. In recent years, a low-grade biogas (mixed gas of CH₄ and CO₂) generated at the time of the methane fermentation treatment of food wastes and domestic animal wastes or a gas containing higher hydrocarbons, such as biodiesel fuel (BDF, C₁₈H_{34.8}O₂), is expected as a candidate of fuel gas for fuel cells.

Since a porous sintered body including a material equivalent to that of a hydrocarbon reforming catalyst is used as the anode in the SOFC and the SOFC is operated at a high temperature at which the reforming reaction occurs, an internal reforming operation in which a hydrocarbon-based fuel is directly supplied can be made in principle. However, when a hydrocarbon-based fuel mixed with steam or carbon dioxide is directly supplied to the anode, a steam reforming reaction or a dry reforming reaction, which is a strong endothermic reaction, occurs within the anode, but there is the following problem: a thermal impulse (thermal shock) leads to destruction of the cell in a short time because of lack of the degree of freedom in the structure of the porous sintered body constituting the anode.

To solve such a problem, there has been reported a SOFC with a reforming catalyst arranged on or above an anode inside the fuel cell, namely, a so-called internal reforming SOFC. For example, an internal reforming SOFC in which city gas is used as fuel gas has been disclosed in Patent Document 1. According to such a configuration, a hydrocarbon fuel is reformed into hydrogen and carbon monoxide by means of the reforming catalyst arranged on or above an anode inside the SOFC, and it is possible to supply a hydrogen-rich reformed gas after reforming to the anode arranged at the subsequent stage of the reforming catalyst. However, a hydrocarbon with 2 or more carbon atoms, from which pyrolytic carbon is easily produced, other than methane as a main component is contained in city gas, and the SOFC is easily susceptible to clogging of the anode due to carbon produced by the pyrolysis of the hydrocarbon and is poor in reliability at the time of prolonged operation.

Therefore, as a fuel cell system using a gas containing hydrocarbons as its fuel, there has been generally used a system configured so that a reforming reaction apparatus having a hydrocarbon reforming catalyst is disposed at the preceding stage of a SOFC, and a gas after reforming is supplied to the SOFC disposed at the subsequent stage to perform power generation.

In such a hydrocarbon gas reforming reaction apparatus, the inside of the reforming reaction apparatus is filled with a granular reforming catalyst made of granules with a catalyst loaded thereon, and fuel gas containing hydrocarbons and steam are passed through the reforming reaction apparatus in which the catalyst is in the state of being heated and activated, to thereby reform a hydrocarbon fuel into fuel gas containing hydrogen, carbon monoxide and carbon dioxide. As a catalyst for reforming, used in such a reforming reaction apparatus, in order to suppress carbon deposition which occurs as a result of the side reaction, a noble metal-supported catalyst such as Ru and Rh which are low in carbon deposition activity has been used (See, Patent Document 1, Paragraph 0037).

However, in the conventional reforming reaction apparatus using the above-mentioned granular reforming catalyst, even when a noble metal catalyst is used, there has not been solved the following problem: the catalyst structure of the granular reforming catalyst is destroyed due to the thermal shock caused by a sudden temperature drop associated with reforming of hydrocarbons and carbon deposition. In particular, in the case of biogas containing CO₂, biodiesel fuel (BDF) containing higher hydrocarbons, or the like, the problem of catalyst clogging due to thermal stress fracture and carbon deposition has been particularly remarkable.

On the other hand, a paper-structured catalyst, which is a catalyst structural body with a paper-like shape, has attracted attention. The paper-structured catalyst is flexible and excellent in totaling processability as compared with a conventional granular reforming catalyst, a fiber network layered structure peculiar to paper gives a preferred catalytic reaction field, and excellent practical performances such as highly enhanced efficiency of the catalytic reaction, inhibition of a side reaction, stabilization of thermal environment, and enhancement in durability of the catalyst are exhibited. For example, a paper-structured catalyst for reforming alcohol has been disclosed in Patent Document 2 and a paper-structured catalyst for reforming methane has been disclosed in Patent Document 3.

However, in the configuration of a known paper-structured catalyst, even when the catalyst is applied to reforming of biogas containing CO₂ or biodiesel containing higher hydrocarbons, the catalyst does not successfully function due to deactivation and the like caused by carbon deposition. Moreover, the reforming catalytic activity against hydrocarbons is not sufficient, and the catalyst cannot be applied to fuel gas such as biogas and biodiesel.

### PRIOR ART DOCUMENTS

### Patent Documents

Patent Document 1: Japanese Patent Laid-open Publication No. 2004-71450

Patent Document 2: Japanese Patent Laid-open Publication No. 2008-307471

Patent Document 3: Japanese Patent Laid-open Publication No. 2011-92825

### SUMMARY OF THE INVENTION

### Problems to be Solved by the Invention

With regard to the conventional paper-structured catalyst, in the case where biogas containing CO₂ or fuel gas containing higher hydrocarbons such as biodiesel is used, problems such as destruction of the catalyst structure due to thermal shock, and clogging and destruction of catalyst voids due to carbon deposition still have not been solved.

Under these circumstances, an object of the present invention is to provide a paper-structured catalyst which has high reforming catalytic activity, allows reforming of a hydrocarbon-based fuel gas to be efficiently performed, and is hardly susceptible to destruction of the catalyst structure and the adjacent material due to thermal shock, and clogging and destruction of catalyst voids.

Moreover, another object of the present invention is to provide a paper-structured catalyst array body which is prepared by arranging multiple sheets of the paper-structured catalyst and is hardly susceptible to destruction of the catalyst structure and the adjacent material due to thermal shock.

Moreover, another object of the present invention is to provide an internal reforming solid oxide fuel cell provided with the paper-structured catalyst.

### Solutions to the Problems

The present invention is as follows.

<1> A paper-structured catalyst, comprising a paper-structured porous support prepared by forming inorganic fibers in a paper-like shape, and catalyst metal which is loaded dispersedly on a surface of the paper-structured porous support and has reforming activity against hydrocarbons, wherein the inorganic fibers constituting the paper-structured porous support contain at least partially ion conductive oxide fibers.

<2> The paper-structured catalyst according to <1>, wherein the ion conductive oxide fibers are at least partially in contact with each other in the paper-structured porous support.

<3> The paper-structured catalyst according to <1> or <2>, wherein a proportion of the ion conductive oxide fibers relative to the whole inorganic fibers constituting the paper-structured porous support is 10% by weight or more.

<4> The paper-structured catalyst according to any one of <1> to <3>, wherein a part of the ion conductive oxide fibers are stabilized zirconia fibers.

<5> The paper-structured catalyst according to any one of <1> to <4>, wherein the paper-structured porous support includes alumina fibers or alumina-silica composite oxide fibers.

<6> The paper-structured catalyst according to <1>, wherein the inorganic fibers constituting the paper-structured porous support are substantially made of ion conductive oxide fibers.

<7> The paper-structured catalyst according to <6>, wherein the ion conductive oxide fibers are stabilized zirconia fibers.

<8> The paper-structured catalyst according to any one of <1> to <7>, wherein the paper-structured porous support is formed by binding the inorganic fibers by a binder containing CeO₂.

<9> The paper-structured catalyst according to any one of <1> to <8>, wherein a porosity of the paper-structured porous support is 75% by volume or more and 95% by volume or less.

<10> The paper-structured catalyst according to any one of <1> to <9>, wherein the catalyst metal is catalyst metal containing Ni and Mg.

<11> A paper-structured catalyst array body prepared by arranging multiple sheets of the paper-structured catalyst according to any one of claims 1 to 10, wherein the multiple sheets are arranged in order from a paper-structured catalyst having a lower reforming performance against hydrocarbons to a paper-structured catalyst having a higher reforming performance against hydrocarbons.

<12> The paper-structured catalyst array body according to <11>, wherein an array of sheets of the paper-structured catalyst is a planar array.

<13> A reforming method of hydrocarbons, comprising supplying a fuel gas mixture containing hydrocarbons and steam or carbon dioxide from the side of the paper-structured catalyst having a lower reforming performance against hydrocarbons in the paper-structured catalyst array body according to <11> or <12>, to sequentially reform the hydrocarbons in the fuel gas mixture by means of the paper-structured catalysts constituting the paper-structured catalyst array body.

<14> The reforming method of hydrocarbons according to <13>, wherein hydrocarbon in the fuel gas mixture is biogas or biodiesel.

<15> A solid oxide fuel cell, comprising a solid electrolyte, an anode arranged on one face of the solid electrolyte, and a cathode arranged on the other face of the solid electrolyte, wherein the paper-structured catalyst according to any one of claims 1 to 10 or the paper-structured catalyst array body according to <11> or <12> is placed before the anode.

<16> The solid oxide fuel cell according to <15>, wherein the paper-structured catalyst or the paper-structured catalyst array body is arranged on the anode.

<17> The solid oxide fuel cell according to <15> or <16>, wherein the solid electrolyte is made of the same ion conductive oxide as that of the ion conductive oxide fibers constituting the paper-structured porous support in the paper-structured catalyst or the paper-structured catalyst array body.

<18> The solid oxide fuel cell according to any one of <15> to <17>, wherein the fuel gas is biogas or biodiesel.

### Effects of the Invention

According to the present invention, there is provided a paper-structured catalyst which has an excellent reforming activity against hydrocarbons, has high durability against thermal stress fracture, is easily moldable/processable into a prescribed size/shape, and is extremely high in degree of freedom of the catalyst array. Moreover, since a paper-structured catalyst array body prepared by arranging multiple sheets of the paper-structured catalyst is hardly susceptible to destruction of the catalyst structure and the adjacent material due to thermal shock, reforming of hydrocarbons can be more stably performed. Moreover, since an internal reforming solid oxide fuel cell prepared with the paper-structured catalyst or the paper-structured catalyst array body as a hydrocarbon reforming catalyst can suppress thermal stress fracture and degradation due to carbon deposition even when reforming of fuel gas containing hydrocarbons is performed, power generation can be more stably performed.

### BRIEF DESCRIPTION OF THE DRAWINGS

FIG. 1 is a conceptual view of the paper-structured catalyst according to the present invention.

FIGS. 2A and 2B show conceptual views of the paper-structured catalyst array body according to the present invention, and FIG. 2A and FIG. 2 show a layered type one and a planar array type one, respectively.

FIG. 3A is a configuration view of a reforming reaction apparatus provided with a paper-structured catalyst according to a first embodiment of the present invention.

FIG. 3B is a configuration view of a SOFC system having a reforming reaction apparatus provided with a paper-structured catalyst according to the first embodiment of the present invention.

FIG. 4 is a conceptual view of a reforming reaction apparatus provided with a paper-structured catalyst array body (layered type) according to a second embodiment of the present invention.

FIG. 5A is a configuration view of an internal reforming SOFC system provided with a paper-structured catalyst according to a third embodiment of the present invention (fuel gas supply: vertical supply system).

FIG. 5B is a schematic view of a SOFC in which a paper-structured catalyst array body is arranged with being in contact with an anode (fuel gas supply: parallel supply system).

FIG. 6 is an appearance photograph of a paper-structured porous support A.

FIGS. 7A and 7B show FE-SEM images of a paper-structured porous support D, and FIG. 7A and FIG. 7B show an image at a magnification of 200 and an image at a magnification of 1000, respectively.

FIGS. 8A-8C show FE-SEM images of a paper-structured catalyst 1A (after reduction), and FIG. 8A, FIG. 8B and FIG. 8C show an overall image of the paper-structured catalyst, an enlarged image of YSZ fiber, and an enlarged image of alumina fiber, respectively.

FIGS. 9A and 9B show scanning probe microscope images of a paper-structured catalyst (after reduction), and FIG. 9A and FIG. 9B show an image of the paper-structured catalyst 1A and an image of the paper-structured catalyst 2A, respectively.

FIGS. 10A and 10B show graphs representing the results of a palm-BDF (C₁₈H_{3.48}O₂) steam reforming test (S/C=3.5) at 800° C. by means of the paper-structured catalyst 1A, FIG. 10A shows graphs of BDF conversion ratio and H₂ and CO concentration in a reformed gas, and FIG. 10B shows graphs of CH₄ and C₂H₄ concentration in the reformed gas.

FIG. 11 shows an FE-SEM image of the paper-structured catalyst 1A after the BDF steam reforming test for 20 hours.

FIGS. 12A-12F show graphs representing the results of a palm-BDF (C₁₈H_{3.48}O₂) steam reforming test (S/C=3.5) at 800° C. using paper-structured catalysts 2A to 2C and a Ru/Al₂O₃ powder catalyst, FIG. 12A shows graphs of BDF conversion ratios, and FIGS. 12B to 12F show (12B) graphs of H₂ concentration, (12C) graphs of CO₂ concentration, (12D) graphs of CO concentration, 12E) graphs of CH₄ concentration, and (12F) graphs of C₂H₄ concentration, respectively.

FIG. 13 is an explanatory diagram of the changes in H₂ concentration and C₂H₄ concentration with time of the paper-structured catalysts 2A to 2C in FIG. 11.

FIGS. 14A and 14B show images of the paper-structured catalyst after the BDF steam reforming test taken through a probe microscope, and FIG. 14A and FIG. 14B show an image of the paper-structured catalyst 1A and an image of the paper-structured catalyst 2A, respectively.

FIGS. 15A and 15B show graphs representing the evaluation results of the dependence on the amount of Ni loaded in a paper-structured catalyst 1E, and 15A and FIG. 15B show a graph of methane conversion ratio and a graph of hydrogen production rate, respectively.

FIG. 16 shows graphs representing the evaluation results of the W/F dependence of the methane conversion ratio in methane dry reforming (CH₄/CO₂=1) using the paper-structured catalyst 1E (amount of Ni loaded: 0.08 to 15.2% by weight) and a Ni/CeO₂ powder catalyst.

FIG. 17 is an explanatory view of a planar type reformer prepared with a planar array type paper-structured catalyst array body.

FIG. 18A is a schematic cross-sectional view of a paper-structured catalyst array body (catalytically-graded) in an example, and FIG. 18B is a schematic cross-sectional view of a comparative example (paper-structured catalyst, not catalytically-graded).

FIG. 19 shows graphs representing the temperature distribution at the time of reforming biogas (simulated gas (CH₄+CO₂), CH₄/CO₂=1) by means of the paper-structured catalyst array body in an example and the paper-structured catalyst in a comparative example.

FIG. 20 shows a graph representing the result of an endurance test of the paper-structured catalyst array body in an example (catalytically-graded).

FIG. 21A is an appearance photograph (after 100 hours) of the paper-structured catalyst array body in an example after the biogas reforming test, and FIG. 21B is an appearance photograph (after 35 hours) in a comparative example.

FIG. 22A shows a schematic cross-sectional view and an appearance photograph of an internal reforming SOFC to which the paper-structured catalyst array body in an example is arranged, and FIG. 22B shows a schematic cross-sectional view and an appearance photograph in a comparative example.

FIG. 23A shows a graph representing the result of an endurance test at the time of supplying biogas (simulated gas (CH₄+CO₂), CH₄/CO₂=1) by means of the internal reforming SOFC to which the paper-structured catalyst array body in an example is arranged, and FIG. 23B shows a graph representing the result of the same test using one uniform paper-structured catalyst in a comparative example.

FIG. 24A shows graphs representing current-voltage (IV) characteristics at the time of supplying biogas (simulated gas (CH₄+CO₂), CH₄/CO₂=1) by means of an external reforming SOFC in an example and a SOFC ((no paper-structured catalyst layered body) in a comparative example.

FIG. 24B shows graphs representing current-voltage (IV) characteristics at the time of supplying a humidified biodiesel by means of the external reforming SOFC in an example and the SOFC (no paper-structured catalyst layered body) in a comparative example.

### DESCRIPTION OF REFERENCE SIGNS

10: Reforming reaction apparatus (first embodiment)
10a: Reforming reaction apparatus
10b: Fuel cell system
11: Reforming reaction apparatus (second embodiment)
12: Fuel cell system (third embodiment)
20: Reforming reaction part
20a: Reforming part
20b: Vaporizing part (heating part)
20c: Fuel cell part
21: Reaction tube
21a: Inlet port
21b: Outlet port
22: Electric furnace (upper tier)
23: Electric furnace (lower tier)
24: Fixing equipment
27a: Anode side inlet port
27b: Anode side outlet port
28a: Cathode side inlet port
28b: Cathode side outlet port
30: Gas supplying part
30A: Hydrocarbon supplying part
30B: Water supplying part
30C: Inert gas supplying part
30D: Carbon dioxide supplying part
30E: Air supplying part
30a to 30e: Flow rate control means
40: Gas chromatograph
41: Cold trap
60: Electrochemical measurement apparatus
P, P1 to P9: Paper-structured catalyst
P′: Paper-structured catalyst array body (layered type)
P″: Paper-structured catalyst array body (planar array type)
A: Anode (fuel electrode)
C: Cathode (air electrode)
E: Solid electrolyte
F: Solid oxide fuel cell (SOFC)

### EMBODIMENTS OF THE INVENTION

Hereinafter, the present invention will be described in detail with reference to examples and the like, but the present invention should not be limited to the following examples and the like, and can be implemented in any other ways without departing from the gist of the present invention.

### <1. Paper-Structured Catalyst>

The present invention relates to a paper-structured catalyst including a paper-structured porous support prepared by forming inorganic fibers in a paper-like shape, and catalyst metal which is loaded dispersedly on a surface of the paper-structured porous support and has reforming activity against hydrocarbons, wherein the inorganic fibers constituting the paper-structured porous support contain at least partially ion conductive oxide fibers (hereinafter, described as “the paper-structured catalyst according to the present invention”).

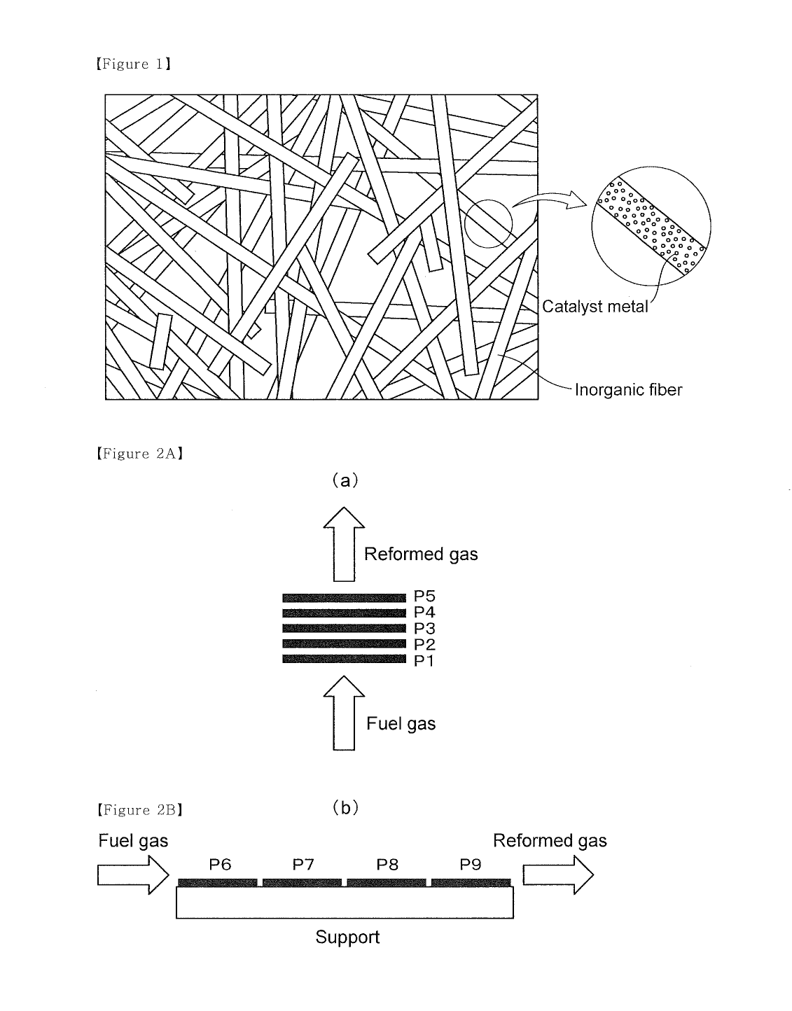

A conceptual view of the paper-structured catalyst according to the present invention is shown in FIG. 1.

In the paper-structured catalyst according to the present invention, inorganic fibers are formed in a paper-like shape to constitute a paper-structured porous support, and the paper-structured catalyst has a configuration in which catalyst metal having reforming activity against hydrocarbons (hereinafter, sometimes referred to as “reforming catalyst”) is loaded on the surface of the support.

In the paper-structured catalyst according to the present invention, since a paper-structured porous support prepared by a paper-making technique capable of micro-control of space and made of inorganic fibers as a skeleton is used as a support, it is possible to enlarge the size of voids in the support. Therefore, the paper-structured catalyst according to the present invention has an excellent resistance against thermal stress fracture associated with the reforming reaction of a hydrocarbon fuel. Furthermore, the ion conductive oxide fibers were contained in the paper-structured porous support function as a promoter, and it is possible to enhance the reforming catalytic activity of the catalyst metal having reforming activity against hydrocarbons and suppress carbon deposition. Therefore, even when carbon is deposited by a side reaction caused by the reforming reaction of a hydrocarbon fuel, it is possible to prevent voids from being completely clogged.

Hereinafter, constituent elements of the paper-structured catalyst according to the present invention will be described in detail.

### <1-1. Paper-Structured Porous Support>

The paper-structured porous support allows catalyst metal to have reforming activity against hydrocarbons to be loaded thereon. The paper-structured porous support is prepared by forming inorganic fibers in a paper-like shape (nonwoven fabric-like shape) and is a support obtained by jointing the inorganic fibers so that the inorganic fibers are entangled with each other, and voids composed of interstices between the inorganic fibers communicate with each other so much that at least air permeability is exhibited.

The porosity of the paper-structured porous support is determined within a range in which the mechanical strength is maintained. When the porosity of the paper-structured porous support is too small, the flow of fuel gas is suppressed and clogging easily occurs, and when the porosity is too large, the mechanical strength is insufficient and destruction easily occurs. In the paper-structured catalyst according to the present invention, the porosity of the paper-structured porous support is preferably 75% by volume or more and 95% by volume or less. The porosity of the paper-structured porous support can be measured by the mercury intrusion technique.

The mercury intrusion technique is a method of applying pressure in order to allow mercury to enter pores of a powder sample, obtaining a mercury intrusion curve expressing the relationship between the pressure applied to mercury and the mercury intrusion amount, and determining a pore distribution curve, a pore volume, a specific surface area, and the like on the basis of the mercury intrusion curve. The mercury

The paper-structured porous support according to the present invention contains ion conductive oxide fibers as at least a part of the inorganic fibers. As an ion conductive oxide, one which has high thermal stability and chemical stability under the conditions of use (for example, 500° C. or higher, reducing atmosphere) of the paper-structured catalyst according to the present invention can be used. Specific examples thereof include a zirconia (ZrO₂)-based oxide, a ceria (CeO₂)-based oxide, and an ion conductive composite oxide (for example, SrTiO₃ and LaAlO₃). Moreover, the ion conductive oxide may be a composite oxide and may contain a dopant. In particular, it is preferred that stabilized zirconia fibers are contained as the ion conductive oxide fibers since the stabilized zirconia fibers are high in chemical stability under a high-temperature reducing atmosphere and have sufficient mechanical strength.

Examples of stabilized zirconia include yttria-stabilized zirconia (YSZ), scandia-stabilized zirconia (ScSZ), and calcia-stabilized zirconia (CSZ). Among them, yttria-stabilized zirconia (YSZ) is preferably used in terms of costs and stability.

As inorganic fibers other than the ion conductive oxide constituting the paper-structured porous support, fibers including an inorganic substance high in thermal stability and chemical stability under the conditions of use (for example, 500° C. or higher, reducing atmosphere) of the paper-structured catalyst according to the present invention can be used. Examples of the inorganic fibers other than the ion conductive oxide include fibers of a metal oxide (ion non-conductive oxide), a metal carbide, a metal nitride, or the like, and these may be used at an arbitrary ratio in combination.

Examples of the metal oxide, which is a ion non-conductive oxide used for the inorganic fibers, include alumina (Al₂O₃), silica (SiO₂), titania (TiO₂), magnesium oxide (MgO), and barium titanate (BaTiO₃). Moreover, the metal oxide may be a composite oxide and may contain a dopant. Examples of the metal carbide include silicon carbide (SiC), molybdenum carbide (Mo₂C), zirconium carbide (ZrC), and titanium carbide (TiC). Examples of the metal nitride include silicon nitride (Si₃N₄), zirconium nitride (ZrN), titanium nitride (TiN), and niobium nitride (NbN).

As described above, the ion conductive oxide fibers contained as a part of the paper-structured porous support according to the present invention function as a promoter to accelerate a hydrocarbon reforming reaction on the catalyst metal. It is preferred that the ion conductive oxide fibers are at least partially in contact with each other in the paper-structured porous support. Such a configuration provides a tendency for the hydrocarbon reforming activity to be enhanced. In order that the ion conductive oxide fibers function as a promoter and the promoting effect for a hydrocarbon reforming reaction on the catalyst metal is sufficiently developed, the proportion of the ion conductive oxide fibers (the whole inorganic fibers are defined as 100% by weight) in the whole inorganic fibers constituting the paper-structured porous support is preferably 10% by weight or more, and more preferably 20% by weight or more (including 100% by weight).

In the case where the mechanical strength of the paper-structured porous support is insufficient, it is preferred in terms of increasing the mechanical strength of the paper-structured catalyst that inorganic fibers with high thermal stability and chemical stability at a temperature in the SOFC operating temperature range are contained in the paper-structured porous support. Preferred examples of the inorganic fibers for increasing the mechanical strength are inorganic fibers composed of alumina (Al₂O₃) or silica-alumina composite oxide (SiO₂—Al₂O₃). In particular, inorganic fibers composed of silica-alumina composite oxide with excellent flexibility is preferred. Although the weight ratio of SiO₂ and Al₂O₃ in the silica-alumina composite oxide can be arbitrarily set, it is preferred that SiO₂/Al₂O₃ is set to 0.25 to 3.

Moreover, in the case where the paper-structured catalyst according to the present invention is arranged in contact with an anode in an internal reforming SOFC, the paper-structured porous support has ionic conductivity, and thus there is a tendency that oxygen ions are supplied to the paper-structured catalyst and the reforming reaction of a hydrocarbon fuel is promoted at an operating temperature of a solid oxide fuel cell. In order to further obtain a promoting effect on the above-mentioned reforming reaction, it is preferred that the inorganic fibers constituting the paper-structured porous support are substantially made of ion conductive oxide fibers. In particular, since stabilized zirconia which is a preferred ion conductive oxide has a sufficient mechanical strength, the paper-structured porous support can be made of only stabilized zirconia fibers.

Moreover, usually, the inorganic fibers constituting the paper-structured porous support each are bonded by a binder component. As the binder component, a conventionally known inorganic binder can be used as long as the binder is a binder that has sufficient chemical stability under the conditions of use of the paper-structured catalyst according to the present invention and is capable of binding the inorganic fibers with a sufficient mechanical strength. Examples thereof include a binder containing an oxide such as Al₂O₃, SiO₂, ZrO₂ or CeO₂. Among them, CeO₂ is preferred as a binder because it has particularly strong effect as a promoter of a hydrocarbon reforming catalyst as well as can bind the inorganic fibers with a sufficient mechanical strength, the hydrocarbon reforming activity of the paper-structured catalyst according to the present invention is enhanced, and furthermore, the generation of coke can be suppressed.

The length and thickness of the inorganic fibers (each of the ion conductive oxide fibers and other inorganic fibers) constituting the paper-structured porous support may be within a range in which the paper-structured porous support can be formed, and are appropriately set in view of the application of the paper-structured catalyst according to the present invention, and the like. The whole length is usually 30 μm to 6 mm and preferably 50 μm to 3 mm, and the diameter is 2 μm to 20 μm. In the case where two or more kinds of inorganic fibers are used, those differing in thickness or length may be used. The length and thickness of the inorganic fibers can be confirmed by means of a scanning electron microscope (SEM).

The size and thickness of the paper-structured porous support are appropriately set in view of the application of the paper-structured catalyst according to the present invention, and the like.

### <1-2. Catalyst Metal Having Reforming Activity Against Hydrocarbons>

In the paper-structured catalyst according to the present invention, although the catalyst metal is not particularly limited as long as the catalyst has reforming activity against hydrocarbons, in the point of having both heat resistance and catalytic activity at an operating temperature (600° C. or higher) of a SOFC which is a preferred application of the paper-structured catalyst according to the present invention, examples thereof include Ni, Co, Fe, Ru, Rh, Pt, Pd and alloys thereof. These metals are appropriately selected depending on the application of the paper-structured catalyst according to the present invention, the composition of fuel gas, the reaction conditions, and the like. For example, since a noble metal such as Pt has a sufficient reforming activity and hardly causes formation of pyrolytic carbon, in the case where the paper-structured catalyst is used for reforming under the condition in which carbon deposition easily occurs, for example, reforming of a low-grade biogas (mixed gas of CH₄ and CO₂) or fuel gas containing higher hydrocarbons such as biodiesel fuel (BDF), the noble metal can be preferably used. Although the catalyst metal is usually produced by reducing a precursor compound thereof (for example, an oxide), the catalyst metal may be a catalyst which is not reduced completely to the metal and which is in part in the state of being a precursor compound as long as the catalyst has reforming activity against hydrocarbons.

On the other hand, since the noble metal is expensive, catalyst metal containing Ni is preferred from the viewpoint of costs. Although Ni is excellent in reforming catalytic property, it has the following problem: formation of pyrolytic carbon easily occurs, and there is a case where carbon deposition cannot be sufficiently suppressed in the case of fuel gas containing higher hydrocarbons such as a BDF. Since catalyst metal containing Ni and Mg is excellent in reforming catalytic property and tolerant to carbon deposition and is inexpensive compared with the noble metal, the catalyst metal is suitable for reforming of fuel gas containing higher hydrocarbons such as a BDF in which carbon deposition easily occurs. The ratio of Ni and Mg (Ni/Mg) in the catalyst metal containing Ni and Mg is usually 0.1 to 4 (atomic ratio) and preferably 0.67 to 1.5 (atomic ratio). This ratio can be measured by means of an EDX analyzer.

For example, the catalyst metal containing Ni and Mg can be obtained by reducing a composite oxide (NiMgO) obtained by drying an aqueous solution containing respective precursors (nitrates or the like) and subsequent heat treatment.

Although the size of the catalyst metal depends on the production method thereof, the average particle diameter usually is within the range of 2 nm to 2 μm, and the average particle diameter is preferably 20 nm or less because the specific surface area is increased and the reforming reaction can be promoted. The average particle diameter of the catalyst metal is a value that is obtained by arbitrarily extracting 100 particles with a scanning electron microscope (SEM) or a transmission electron microscope (TEM), measuring particle diameters (diameters) for the respective particles, and calculating the average value of the particle diameters of 100 particles. In the case where the shape of the catalyst metal is a shape other than a spherical shape, a diameter obtained by measuring the perimeter of each particle in a microscope image with analyzing software and defining the perimeter as the perimeter of a circle is defined as the particle diameter. As described later, in the case where the paper-structured catalyst according to the present invention is used before the anode in an internal reforming SOFC, it is preferred that the particle diameter is 100 nm to 1 μm in view of balance with the catalytic activity because the catalyst metal easily agglomerates under SOFC operating conditions (for example, 800° C., reducing atmosphere) when the catalyst metal has a particle diameter of 50 nm or less.

The loaded amount of the catalyst metal is appropriately selected according to the kind of the catalyst metal, the application of the paper-structured catalyst, the composition of fuel gas, and the like. The loaded amount of the catalyst metal is usually within the range from 0.1 to 25% by weight when the whole paper-structured catalyst is defined as 100% by weight. In the case of catalyst metal made of only Ni or catalyst metal containing Ni and Mg, from the standpoint of keeping a balance between the catalytic activity and dispersibility, it is preferred that the amount of the catalyst metal loaded be 0.5 to 20% by weight on the basis of weight in terms of Ni.

The production method of the paper-structured catalyst of the present invention, namely, a method for dispersing or loading catalyst metal on the surface of a paper-structured porous support is not particularly limited, and examples thereof include a method of immersing a paper-structured porous support in a solution containing a precursor of the catalyst metal and then producing the catalyst metal with a particulate shape on the surface of the paper-structured porous support by drying, firing, a reduction treatment, and the like.

Moreover, in the production method of a paper-structured porous support by the above-described wet paper-making method, a slurry prepared by adding the precursor of the catalyst metal together with inorganic fibers and a binder component may be used to simultaneously perform paper-making of a paper-structured porous support and loading of the catalyst metal on the paper-structured porous support. By this method, a paper-structured catalyst containing the uniformly dispersed catalyst metal can be obtained more simply. The precursor of the catalyst metal may be a precursor which is converted into the catalyst metal with a particulate shape by a method such as a heat treatment and a reduction treatment, and a nitrate, a carbonate, a sulfate, an acetate, a halide, an ammonium salt, an oxalate, and the like of respective metals may be appropriately selected and used.

### <1-3. Other Components>

Although the paper-structured catalyst according to the present invention has a basic configuration of a paper-structured porous support and catalyst metal loaded thereon, the paper-structured catalyst may contain other components without impairing the object of the present invention. Examples thereof include a promoter component for further enhancement of catalytic activity, and a binder for jointing the paper-structured catalyst to other component materials. For example, a preferred example of other components includes barium titanate (BaTiO₃) since barium titanate has high carbon deposition inhibitory effect.

### <2. Application of Paper-Structured Catalyst According to the Present Invention>

The paper-structured catalyst according to the present invention can be preferably used as a reforming catalyst for a conventional reforming catalytic apparatus or a reforming catalyst for an internal reforming solid oxide fuel cell in place of a granular catalyst. The paper-structured catalyst according to the present invention may be used as a single-layered one and may be used as a paper-structured catalyst array body prepared by arranging (layering) a prescribed number of sheets thereof depending on the purpose thereof.

Hereinafter, as preferred application examples of the paper-structured catalyst according to the present invention, a paper-structured catalyst array body suitable especially for tolerance of thermal stress fracture and an internal reforming solid oxide fuel cell provided with the paper-structured catalyst (including a paper-structured catalyst array body) according to the present invention will be described.

### <2-1. Paper-Structured Catalyst Array Body>

The paper-structured catalyst array body according to the present invention is a paper-structured catalyst array body prepared by arranging a plurality of paper-structured catalysts having the above-mentioned configuration of the present invention, wherein the paper-structured catalysts are arranged in order from a paper-structured catalyst having a lower reforming performance against hydrocarbons to a paper-structured catalyst having a higher reforming performance against hydrocarbons.

Such a configuration can allow a uniform reforming reaction to occur in order from a paper-structured catalyst having a lower reforming performance against hydrocarbons to a paper-structured catalyst having a higher reforming performance against hydrocarbons along the fuel flow direction. As a result thereof, the temperature unevenness inside the paper-structured catalyst array body derived from the reforming reaction (endothermic reaction) is reduced, the temperature distribution can be made uniform, and the paper-structured catalyst array body, the paper-structured catalysts constituting the paper-structured catalyst array body and the adjacent material are more hardly susceptible to thermal stress fracture.

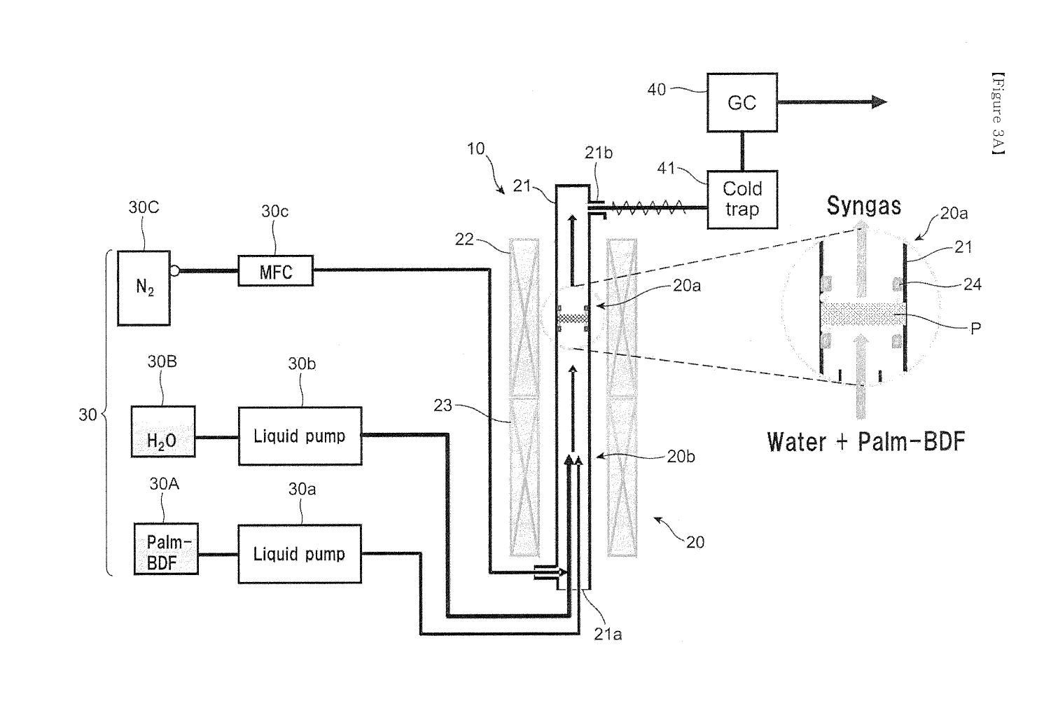

The paper-structured catalyst array body may be a layered type (see FIG. 2A, sometimes referred to as a paper-structured catalyst layered body) prepared by layering and arranging a plurality of paper-structured catalysts, or a planar array type prepared by arranging a plurality of paper-structured catalysts in a plane (in the horizontal direction). The planar array type paper-structured catalyst array body may be prepared by arranging the paper-structured catalysts on a support (see FIG. 2B). In the case where a planar array type paper-structured catalyst array body is used in an internal reforming SOFC, the SOFC itself may be employed as a support. In the case of a layered type paper-structured catalyst array body, fuel gas is supplied along the vertical direction to the respective faces of the paper-structured catalysts in the paper-structured catalyst array body, and reformed. In the case of a planar array type paper-structured catalyst array body, fuel gas is supplied along a direction parallel with the respective faces of the paper-structured catalysts in the paper-structured catalyst array body. Even in the parallel supply system, the paper-structured catalysts are arranged in order from a paper-structured catalyst having a lower reforming performance against hydrocarbons to a paper-structured catalyst having a higher reforming performance against hydrocarbons.

The reforming performance against hydrocarbons can be designed by appropriately selecting the kind of catalyst metal, the amount of the catalyst metal loaded, the kind of a paper-structured porous support, and characteristics such as porosity.

The reforming method of hydrocarbons according to the present invention is a reforming method of hydrocarbons, using the above-mentioned paper-structured catalyst array body, and includes supplying a mixed gas of fuel gas containing hydrocarbons and steam or carbon dioxide from the side of the paper-structured catalyst having a lower reforming performance against hydrocarbons in the paper-structured catalyst array body, to sequentially reform the mixed gas by means of the paper-structured catalysts constituting the paper-structured catalyst array body. By such a method, the temperature unevenness inside the paper-structured catalyst array body is reduced, the temperature distribution can be made uniform, the paper-structured catalyst array body, the paper-structured catalysts constituting the array body and the adjacent material are more hardly susceptible to thermal stress fracture, and therefore reforming of hydrocarbons can be stably performed for a long period of time.

As described above, since carbon deposition is suppressed and the paper-structured catalyst according to the present invention is hardly susceptible to thermal stress fracture even in the case where the paper-structured catalyst is used for reforming of a hydrocarbon fuel gas easily causing carbon deposition (for example, low-grade biogas (mixed gas of CH₄ and CO₂) or fuel gas containing higher hydrocarbons such as biodiesel fuel (BDF)), reforming can be continuously performed in the paper-structured catalyst array body according to the present invention over a long period of time even when biogas or biodiesel is used as fuel gas.

### <2-2. Internal Reforming Solid Oxide Fuel Cell>

Hereinafter, an internal reforming solid oxide fuel cell which is a preferred usage example of the paper-structured catalyst according to the present invention (hereinafter, described as “the SOFC according to the present invention”) will be described.

The SOFC according to the present invention is provided with a solid electrolyte, an anode arranged on one face of the solid electrolyte, and a cathode arranged on the other face of the solid electrolyte, wherein the paper-structured catalyst according to the present invention is arranged on or above the anode.

According to such a configuration, since a hydrocarbon-based fuel gas is reformed into hydrogen and carbon monoxide by means of the paper-structured catalyst according to the present invention arranged on or above the anode in the internal reforming SOFC, a hydrogen-rich reformed gas can be supplied to the anode. Therefore, destruction of an anode structure due to a sudden temperature drop associated with the reforming of hydrocarbons and clogging of voids of the anode due to coke, which cause problems in the case where reforming is performed by means of the above-described anode itself, can be suppressed.

Moreover, as described above, since carbon deposition is suppressed even in the case where the paper-structured catalyst according to the present invention is used for reforming of a hydrocarbon fuel gas easily causing carbon deposition (for example, low-grade biogas (mixed gas of CH₄ and CO₂) or fuel gas containing higher hydrocarbons such as biodiesel fuel (BDF)), power generation can be continuously performed in the SOFC according to the present invention over a long period of time even when biogas or biodiesel is used as fuel gas.

Although an internal reforming SOFC in which a powdered or granular reforming catalyst is arranged on or above the anode has hitherto existed, the paper-structured catalyst according to the present invention to be applied to the SOFC according to the present invention is extremely high in degree of freedom at the time of catalyst arranging or layering as compared with a powdered or granular reforming catalyst conventionally used. Therefore, as compared with a conventional internal reforming SOFC in which a powdered or granular reforming catalyst is simply arranged on or above the anode, the SOFC according to the present invention has the following advantages: setting and replacement of a reforming catalyst are easy and optimal paper-structured catalysts can be used in combination in view of various conditions such as the kind of fuel gas used.

In the SOFC according to the present invention, it is preferred that the paper-structured catalyst or the paper-structured catalyst array body be arranged with being in contact with the anode. According to such a configuration, oxygen ions (O²⁻) are supplied to the paper-structured catalyst via the anode, the reforming reaction in the paper-structured catalyst is promoted, and carbon deposition is further suppressed.

The paper-structured catalyst array body according to the present invention prepared by arranging paper-structured catalysts in order from a paper-structured catalyst having a lower reforming performance against hydrocarbons to a paper-structured catalyst having a higher reforming performance against hydrocarbons may be arranged on or above the anode in the internal reforming SOFC, and may be arranged with being in contact with the anode. As described above, a uniform reforming reaction in the fuel flow direction can occur, the temperature distribution in the paper-structured catalyst array body can be made uniform, and the paper-structured catalyst and the anode are hardly susceptible to thermal stress fracture even in the case where a hydrocarbon-based fuel is used. In particular, in the case where biogas or biodiesel is used as fuel gas, the temperature distribution in the reaction field is non-uniform by reforming, carbon deposition is significantly promoted when a part where the local temperature drop occurs exists, and thus the paper-structured catalyst array body according to the present invention is more preferably used.

In the SOFC according to the present invention, it is preferred that the solid electrolyte be made of the same ion conductive oxide as that of the ion conductive oxide fibers constituting the paper-structured porous support. When the solid electrolyte is made of the same ion conductive oxide as that of the ion conductive oxide fibers constituting the paper-structured porous support in this way, chemical/mechanical matching can be enhanced and degradation can be suppressed. In this context, “the same ion conductive oxide” may have the same ion conductive oxide as the base, and any dopant is acceptable. In the case of stabilized zirconia, preferred specific examples thereof include scandia-stabilized zirconia (ScSZ) for the solid electrolyte and yttria-stabilized zirconia (YSZ) for the ion conductive oxide fibers.

Hereinafter, preferred embodiments of the paper-structured catalyst according to the present invention will be described with reference to the drawings. The present invention should not be limited to the following embodiments and can be implemented in any other ways without departing from the gist of the present invention. Moreover, in all drawings, the same reference signs are attached to the same constituent elements, and the description is properly omitted.

### First Embodiment

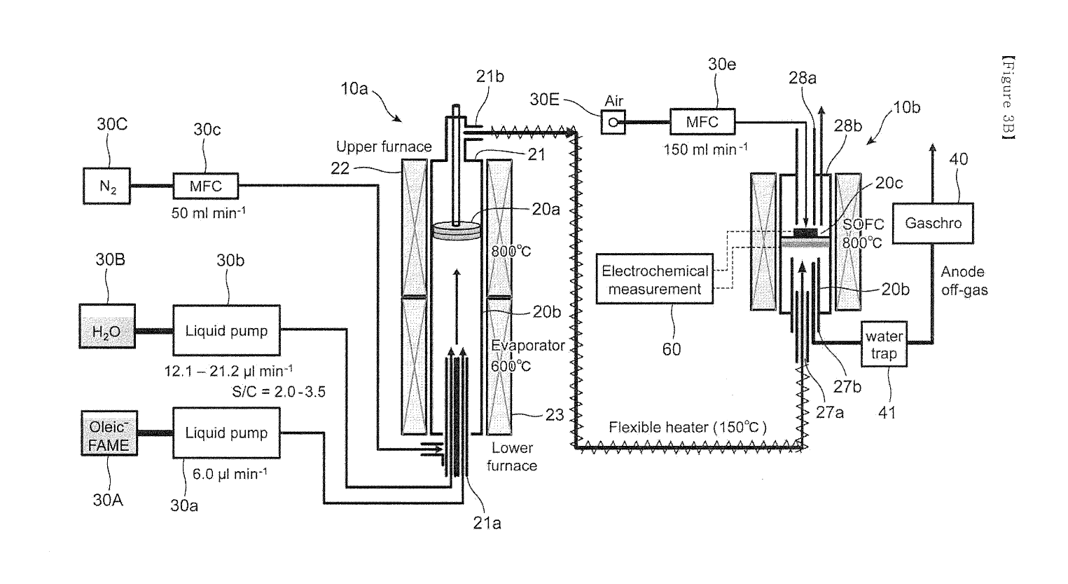

FIG. 3A is a conceptual view of a reforming reaction apparatus prepared with a paper-structured catalyst according to a first embodiment of the present invention. A reforming reaction apparatus 10 according to the present embodiment is provided with a reforming reaction part 20 and a gas supplying part 30 for supplying fuel gas to the reforming reaction part 20.

The reforming reaction part 20 includes a reaction tube 21 for allowing a paper-structured catalyst to be arranged at a prescribed position, and electric furnaces 22, 23 for heating the reaction tube 21 to a prescribed temperature. The reaction tube 21 includes a reforming part 20a and a vaporizing part 20b, and the temperatures thereof can be controlled to different temperatures by the electric furnace 22 at the upper tier and the electric furnace 23 at the lower tier, respectively.

With regard to the material of the reaction tube 21 used in the present embodiment, although an alumina tube is used as the reaction tube, the reaction tube may be one chemically stable in a temperature range (about 800° C.) for performing a hydrocarbon reforming reaction.

The gas supplying part 30 is a mechanism for supplying fuel gas, and is configured by a hydrocarbon supplying part 30A, a water supplying part 30B and an inert gas supplying part 30C. With these, prescribed amounts of a hydrocarbon fuel, water and an inert gas (N₂) are supplied into the reaction tube 21 through an inlet port 21a of the reaction tube 21 in the state where the amounts are controlled by appropriate flow rate control means 30a to 30c, are vaporized in the vaporizing part 20b, and thereafter supplied as fuel gas to the reforming part 20a provided with a paper-structured catalyst P. The fuel gas supplied is reformed by the paper-structured catalyst P and then exhausted through an outlet port 21b.

In the present embodiment, since a palm-BDF is used as the hydrocarbon which is fuel, the flow rate is controlled by a fluid pump (Liquid Pump), but in the case where a gaseous hydrocarbon is used as fuel, the flow rate may be controlled with a mass flow controller (MFC) or the like.

The palm-BDF and water supplied are turned to gases in the vaporizing part 20b, and the gases are reformed by means of the paper-structured catalyst arranged at the upper tier (subsequent stage) in the reaction tube 21 to produce a hydrogen-rich reformed gas.

As shown in an enlarged view of the reforming part 20a in FIG. 3A, the paper-structured catalyst P is fixed by means of fixing equipment 24. The fixing equipment 24 is designed so as to be adjusted depending on the thickness of the paper-structured catalyst and the number of layered paper-structured catalysts.

The paper-structured catalyst is the paper-structured catalyst according to the present invention described above. The constitution of the paper-structured catalyst is appropriately selected in view of the components of fuel gas used and the concentration thereof. In the present embodiment, although a sheet of the paper-structured catalyst is used, two or more sheets thereof can also be arranged to be used.

The reformed gas is exhausted through the outlet port 21b of the reaction tube 21. In the present embodiment, the reforming reaction apparatus 10 is provided with a gas chromatograph 40 for component analysis in order to analyze a gas exhausted, and a reformed gas produced can be analyzed with an automatic gas chromatograph and the conversion ratio of the fuel and the concentration of respective components (hydrogen, carbon monoxide, carbon dioxide, methane, ethylene, and the like) in the reformed gas can be measured. In the case where the component analysis is not performed, the gas chromatograph 40 is unnecessary.

The reforming reaction apparatus 10 according to the present embodiment can be used as a reforming reaction apparatus for reforming various hydrocarbons. Moreover, the reforming reaction apparatus 10 is also preferably used as a pre-reformer in a fuel cell system. That is, power generation can be performed by disposing a fuel cell system (not illustrated) at the subsequent stage of the reforming reaction apparatus 10 and supplying a hydrogen-rich reformed gas exhausted from the reforming reaction apparatus 10 as fuel gas to the fuel cell system.

In the present embodiment, although a mixed gas (steam/carbon ratio (S/C)=3.5) of a palm-BDF and steam is used as fuel gas, the present embodiment is merely illustrative of the present invention. Various hydrocarbons (for example, methane, ethane, propane, city gas, an alcohol, and the like) may be used as the raw material hydrocarbon in place of the palm-BDF, carbon dioxide may be used as a gas for reforming, in place of steam, and the ratio of S/C may be changed. For example, in the case where the raw material hydrocarbon is methane, ethane, propane or city gas, the ratio of S/C satisfies the following expression: S/C=about 1.0 to 3.0, and in the case where the raw material hydrocarbon is an alcohol such as ethanol, the ratio of S/C satisfies the following expression: S/C=about 0.5 to 1.5.

Moreover, biogas (CH₄/CO₂=1) which is a mixed gas of methane and carbon dioxide may be used as the fuel gas. Moreover, as necessary, the ratio of CH₄/CO₂ in the fuel gas may be changed by adding CH₄ or CO₂ to the biogas, and other hydrocarbon fuels may be added thereto without causing carbon deposition.

Moreover, the reforming conditions including the gas flow rate, the temperature and the like, in view of the kind of the hydrocarbon contained in fuel gas, the ratio of S/C, and the like, may be appropriately determined considering preferred conditions to obtain the excellent conversion ratio of the fuel gas and less generation of by-products (ethylene and the like). The reforming temperature is usually about 500 to 900° C., and the contact time (W/F) is about 0.001 to 1.5 g-cat h mol⁻¹.

Moreover, as shown in FIG. 3B, an external reforming SOFC can be used in which the reforming reaction apparatus 10a according to the present embodiment and the SOFC system 10b are arranged in series to perform reforming of fuel gas in the reforming reaction apparatus 10a, and power generation is performed in the SOFC system 10b using the reformed gas as fuel gas.

### Second Embodiment

FIG. 4 is a conceptual view of a reforming reaction apparatus prepared with a paper-structured catalyst array body according to a second embodiment of the present invention.

A reforming reaction apparatus 11 according to the present embodiment is an apparatus in which a layered type paper-structured catalyst array body P′ is used in a reforming reaction part 20 in place of the paper-structured catalyst P. In the reforming reaction apparatus 11, since constituent elements other than the constituent elements of the reforming reaction part 20 and the constituent elements of a part of a gas supplying part 30 are the same constituent elements as those in the reforming reaction apparatus 10 according to the first embodiment described above, the description is properly omitted.

The gas supplying part 30 in the present embodiment has the same configuration as that in the above-mentioned first embodiment except that methane is used as the hydrocarbon in the hydrocarbon supplying part 30A and a carbon dioxide supplying part 30D is used in place of the water supplying part 30B.

Methane and CO₂, which are supplied into the reaction tube 21 by means of the gas supplying part 30 at a flow rate such that the following expression: CH₄/CO₂=1; is satisfied, are preheated in a heating part 20b heated to a proper temperature, then, supplied to a reforming part 20a provided with a paper-structured catalyst array body P′, reformed by means of the paper-structured catalyst array body P and then exhausted through an outlet port 21b.

The paper-structured catalyst array body P′ is an array body prepared by arranging multiple sheets of the above-described paper-structured catalysts according to the present invention, and in the present embodiment, as shown in an enlarged view of the reforming part 20a in FIG. 4, five sheets of paper-structured catalysts P1 to P5 are arranged.

The paper-structured catalysts P1 to P5 constituting the paper-structured catalyst array body P′ are paper-structured catalysts differing in reforming performance against hydrocarbons, and are arranged so that the reforming performance against hydrocarbons is higher in the order of P1 which has the lowest reforming performance against hydrocarbons, P2, P3, P4 and P5.

Since the reforming reaction of hydrocarbons is an endothermic reaction, fuel gas mixed with steam or carbon dioxide is supplied to a paper-structured catalyst, to thereby reduce the temperature.

Since the drop in temperature (the amount of heat absorption) depends on the amount of hydrocarbons reformed, in the case of the paper-structured catalyst array body, the temperature drop is the largest in the paper-structured catalyst (P1 in FIG. 4) which is firstly brought into contact with a mixture of hydrocarbons and steam or carbon dioxide of an initial concentration (before reforming) and is in the forefront. Since the hydrocarbon concentration is reduced as the mixture moves toward the subsequent stage, the amount of heat absorption due to the reforming reaction is also reduced and the drop in temperature is also smaller. In particular, when the reforming activity of the paper-structured catalyst at the preceding stage is too high, a large amount of hydrocarbons is reformed at the part, the hydrocarbon concentration at the subsequent stage is lower, and there is a case where the paper-structured catalyst at the subsequent stage hardly contributes to the reforming reaction, and as a result thereof, a large temperature difference may be generated between the preceding stage and the subsequent stage in the paper-structured catalyst array body. In such a case, there is a possibility that a paper-structured catalyst array body or a member adjacent to the paper-structured catalyst array body is broken due to thermal shock caused by the temperature unevenness generated depending on the position of the paper-structured catalyst in the paper-structured catalyst array body. On the other hand, when only paper-structured catalysts having a lower reforming performance against hydrocarbons are arranged in order to suppress the endothermic reaction, there is a possibility that unreacted hydrocarbons remain in a reformed gas.

In the paper-structured catalyst array body P′ according to the present embodiment, since the paper-structured catalyst P1 which has a lower reforming performance against hydrocarbons, P2 which has a higher reforming performance than that of P1, P3, P4 and P5 are arranged in this order, a reforming reaction is evenly allowed to occur in the fuel flow direction. As a result thereof; the temperature difference among paper-structured catalysts P1 to P5 derived from the reforming reaction (endothermic reaction) is smaller, the equalization of temperature distribution inside the paper-structured catalyst array body P′ can be attained, and by application of the paper-structured catalyst array body P′, a reforming reaction part in which this itself and the adjacent material are hardly susceptible to thermal stress fracture is attained.

The reforming performance against hydrocarbons can be designed by appropriately selecting the kind of catalyst metal, the amount of the catalyst metal loaded, the kind of a paper-structured porous support, and characteristics such as porosity. Since the reforming performance against hydrocarbons easily depends particularly on the kind of catalyst metal and the amount of the catalyst metal loaded, the reforming performance against hydrocarbons of the paper-structured catalyst to be used is usually controlled by the kind of catalyst metal and the amount of the catalyst metal loaded.

Moreover, in the present embodiment, although paper-structured catalysts of P1, P2, P3, P4 and P5 differing in the reforming performance from one another are used, the paper-structured catalysts may be arranged from a paper-structured catalyst having a lower reforming performance to a paper-structured catalyst having a higher reforming performance as the whole paper-structured catalyst array body. As well as paper-structured catalysts differing in the reforming performance from one another (that is, reforming performance: P1<P2<P3<P4<P5) as in the present embodiment, paper-structured catalysts in which some paper-structured catalysts have the same reforming performance (for example, reforming performance: P1=P2<P3<P4=P5) may be used.

Although a vertical supply system in which fuel gas is supplied along the vertical direction to the respective faces of the paper-structured catalysts in the paper-structured catalyst array body is used in the present embodiment, without being limited to this system, a parallel supply system in which fuel gas is supplied along a direction parallel with the respective faces of the paper-structured catalysts in the paper-structured catalyst array body may be used. Even in the parallel supply system, the paper-structured catalysts are arranged in order from a paper-structured catalyst having a lower reforming performance against hydrocarbons to a paper-structured catalyst having a higher reforming performance against hydrocarbons. A specific example of using a paper-structured catalyst array body in which the parallel supply system is employed will be described in EXAMPLES described later.

Moreover, in the present embodiment, although a mixed gas (CH₄/CO₂=1) of methane and carbon dioxide is used as fuel gas by assuming biogas, the present embodiment is merely illustrative of the present invention, and the ratio of CH₄/CO₂ may be changed.

In the case where an actual biogas (CH₄/CO₂=1) is used as the fuel gas, as necessary, the ratio of CH₄/CO₂ in the fuel gas may be changed by adding CH₄ or CO₂ to the biogas, and other hydrocarbon fuels may be added thereto without causing carbon deposition.

As the fuel gas, an actual biogas may be used, or various hydrocarbons (for example, methane, ethane, propane, city gas, an alcohol, and biodiesel) may be used in place of methane, and as a gas for reforming, steam may be used in place of carbon dioxide. For example, in the case where the raw material hydrocarbon is methane, ethane, propane or city gas, the ratio of S/C satisfies the following expression: S/C=about 1.0 to 3.0, in the case where the raw material hydrocarbon is biodiesel, the ratio of S/C satisfies the following expression: S/C=about 2.0 to 3.5, and in the case where the raw material hydrocarbon is an alcohol such as ethanol, the ratio of S/C satisfies the following expression: S/C=about 0.5 to 1.5.

Moreover, the reforming conditions including the gas flow rate, the temperature and the like, in view of the kind of the hydrocarbon contained in fuel gas, the ratio of S/C, and the like, may be appropriately determined considering preferred conditions to obtain the excellent conversion ratio of the fuel gas and less generation of by-products (ethylene and the like).

The reforming temperature is usually about 500 to 900° C., and the contact time (W/F) is about 0.001 to 1.5 g-cat h mol⁻¹.

### Third Embodiment

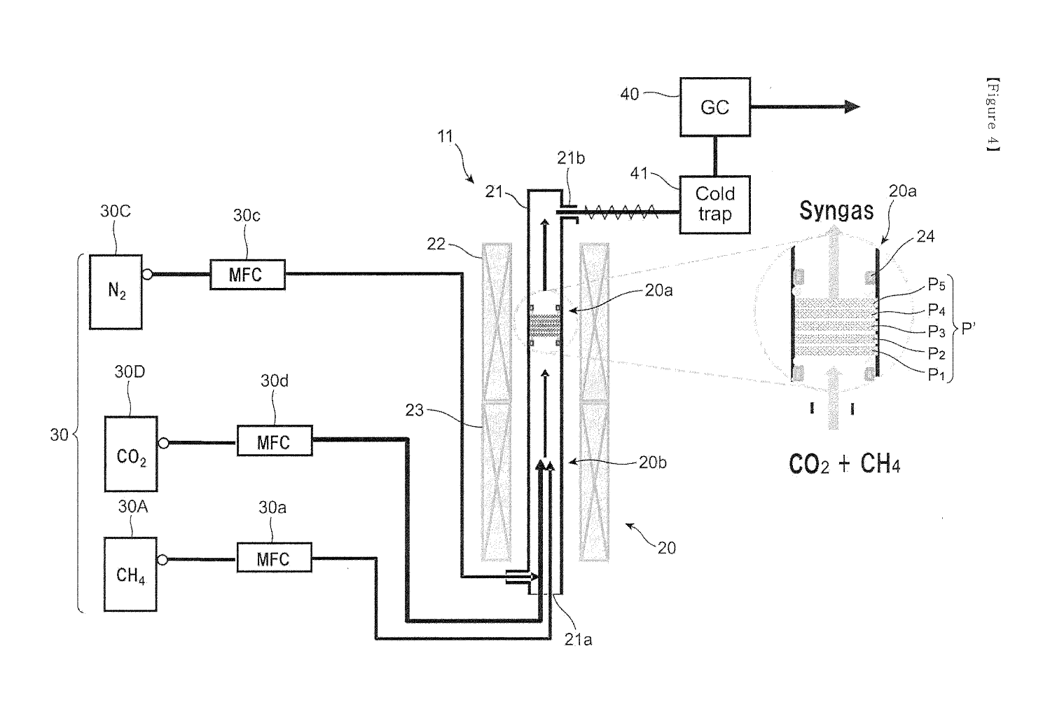

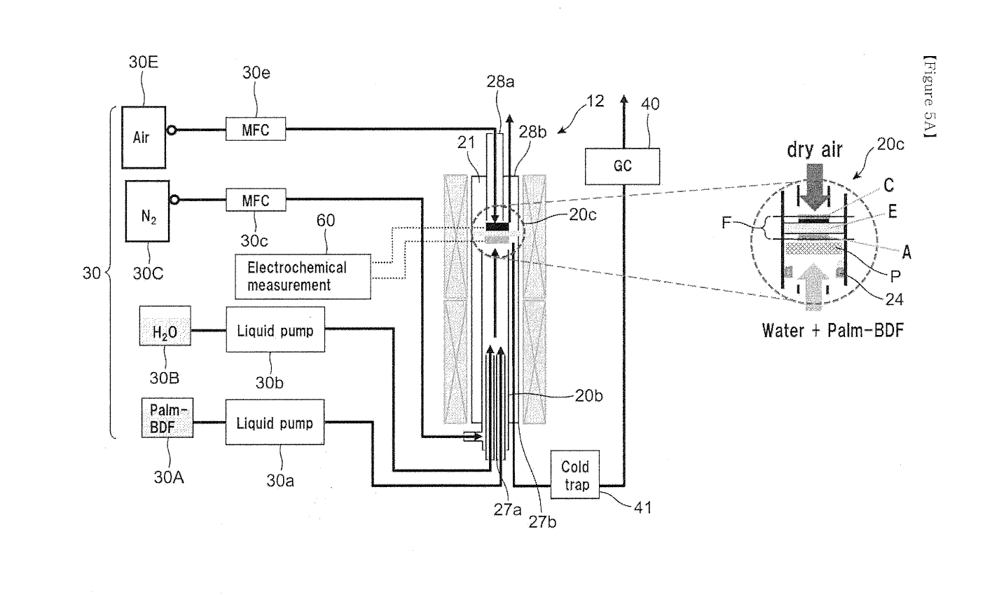

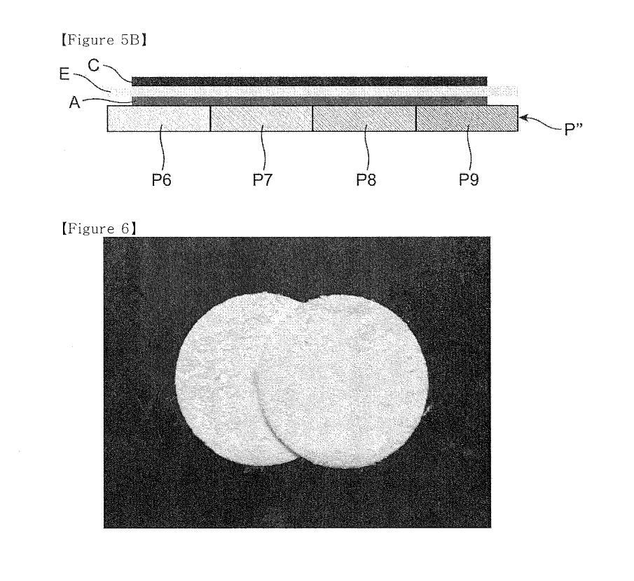

FIG. 5A is a conceptual view of an internal reforming SOFC system according to a third embodiment of the present invention.

A fuel cell system 12 according to the present embodiment is a system provided with a fuel cell part 20c including a solid oxide fuel cell F in place of the reforming part 20a in the above-mentioned first and second embodiments. Moreover, in response to this, the constitutions of the reaction tube 21 and the gas supplying part 30 are changed.

As shown in an enlarged view of the fuel cell part 20c in FIG. 5A, the solid oxide fuel cell F according to the present embodiment is provided with a solid electrolyte E, an anode A arranged on one face of the solid electrolyte E, and a cathode C arranged on the other face of the solid electrolyte E, and the above-described paper-structured catalyst P according to the present invention is arranged at the preceding stage of the anode.

The solid oxide fuel cell F according to the present embodiment is a fuel cell prepared by directly diverting a conventionally known solid oxide fuel cell. The constituent elements will be briefly described.

The solid electrolyte E is a gas non-permeable dense membrane made of an oxygen ion conductive oxide. As the material therefor, an oxygen ion conductive oxide known as an electrolyte for a solid oxide fuel cell can be used, and examples thereof include stabilized zirconia (YSZ, ScSZ and the like) and a ceria-based oxide (SDC, GDC and the like). In particular, when the solid electrolyte E is made of the same ion conductive oxide as that of the ion conductive oxide fibers constituting the paper-structured porous support constituting the paper-structured catalyst P, the solid electrolyte E is preferred because a problem of contamination is avoided under fuel cell operating conditions (high temperatures (about 800° C.) and reducing atmosphere).

The anode A includes a so-called cermet prepared by mixing a metal powder having hydrogen oxidative activity and an oxygen ion conductive oxide powder, and firing the mixture. Examples of the metal having hydrogen oxidative activity include Ni and an alloy thereof. As the oxygen ion conductive oxide powder, the same oxygen ion conductive oxide as the oxygen ion conductive oxide for the solid electrolyte E is used. “The same oxygen ion conductive oxide” may have the same ion conductive oxide as the base, and any dopant is acceptable.

Therefore, when the oxygen ion conductive oxide constituting the anode A and the ion conductive oxide fibers constituting the paper-structured porous support constituting the paper-structured catalyst P have the same oxygen ion conductive oxide, chemical/mechanical matching among the solid electrolyte E, the anode A and the paper-structured catalyst P can be enhanced and degradation can be suppressed.

As the cathode C, for example, an electroconductive metal oxide with a perovskite type structure can be used, and examples thereof include (La, Sr)MnO₃ and (Sm, Sr)CoO₃.

Although each of the thicknesses of the solid electrolyte E, the anode A and the cathode C varies with the shape thereof, the purpose of use, and the like, the thickness of the solid electrolyte E is about 100 to 500 μm, the thickness of the anode A is about 20 to 100 μm, and the thickness of the cathode C is about 20 to 100 μm in the case of a solid electrolyte-supported type.

In the solid oxide fuel cell F according to the present embodiment, each of the anode A and the cathode C is connected to an electrochemical measurement apparatus 60 and designed so that various electrochemical evaluations can be performed.

In the case of simply performing power generation, the electrochemical measurement apparatus 60 is unnecessary and only the external load may be applied.

In the present embodiment, although an example in which the fuel cell part 20c constitutes a unit cell is illustrated, practically, a fuel cell stack prepared with the prescribed number of unit cells layered depending on the power generation performance is formed, and is used by being assembled with other apparatuses associated therewith. In this case, the paper-structured catalyst P may be arranged on or above the anode in the unit cell to which a hydrocarbon fuel gas substantially before reforming is supplied.

In the fuel cell system 12 according to the present embodiment, a palm-BDF which is fuel and water are supplied by means of a hydrocarbon supplying part 30A and a water supplying part 30B, respectively, into a reaction tube 21 through an anode side inlet port 27a, and those are vaporized in a vaporizing part 20b, after which the vaporized gas is supplied to the fuel cell part 20c. In the fuel cell part 20c, steam reforming of the palm-BDF is performed by means of the paper-structured catalyst P arranged at the preceding stage of the anode A, and a hydrogen-rich reformed gas is supplied to the anode A and used for power generation.

Moreover, an exhaust gas is exhausted through an outlet port 27b, and steam is condensed by a cold trap 41 and removed as moisture, after which the exhaust gas is analyzed by a gas chromatograph 40 for component analysis, and the conversion ratio of the fuel and the concentration of respective components (hydrogen, carbon monoxide, carbon dioxide, methane, ethylene, and the like) in the exhaust gas can be measured. In the case where the component analysis is not performed, the gas chromatograph 40 is unnecessary.

On the other hand, air is supplied to the cathode C arranged on the opposite side face of the anode A by means of an air supplying part 30E through an inlet port 28a. As a result thereof, a potential difference due to the oxygen potential difference is generated between the anode A and the cathode C, and it is possible to supply power to the outside.

As compared with the powdered or granular reforming catalyst conventionally used, the paper-structured catalyst P according to the present invention is extremely high in degree of freedom at the time of catalyst arranging or layering. Therefore, optimal paper-structured catalysts can be combined and used in view of various conditions such as the kind of fuel gas used.

Since the paper-structured catalyst P exhibits high hydrocarbon reforming performance and is hardly susceptible to carbon deposition, power generation can be continuously performed over a long period of time in the SOFC even when biogas or biodiesel is used as fuel gas.

In the present embodiment, the paper-structured catalyst P is arranged with being in contact with the anode A. According to such a configuration, when power generation is performed with the solid oxide fuel cell F, O²⁻ is supplied to the paper-structured catalyst P via the anode A, the reforming reaction in the paper-structured catalyst P is promoted, and carbon deposition is further suppressed.

It is not always necessary to bring the paper-structured catalyst P and the anode A into contact with each other, and in particular, in the case where a difference in coefficient of thermal expansion between the paper-structured catalyst P and the anode A is large, or the like, it is preferred not to bring them into contact with each other.

In the present embodiment, although a sheet of the paper-structured catalyst P is arranged, two or more sheets thereof may be arranged. Moreover, the paper-structured catalyst array body P′ described in the second embodiment may be arranged on or above the anode. When the array is devised as described above, a reforming reaction in the fuel flow direction can uniformly occur, and thus the temperature distribution in the paper-structured catalyst array body P′ can be made uniform.

Moreover, in the case where the paper-structured catalyst array body P′ described in the second embodiment is used, fuel gas is supplied by a vertical supply system, and, without being limited to this system, the paper-structured catalyst array body may be disposed so that fuel gas is supplied by a parallel supply system.

A schematic view of a SOFC in which a paper-structured catalyst array body is arranged with being in contact with the anode (fuel gas: parallel supply system) is shown in FIG. 5B.

As shown in FIG. 5B, the paper-structured catalyst array body P″ in the embodiment is an array body in which four sheets of paper-structured catalysts of P6, P7, P8 and P9 differing in reforming performance against hydrocarbons are arranged so that the reforming performance against hydrocarbons is higher in the order of P6 which has the lowest reforming performance against hydrocarbons, P7, P8 and P9, and the paper-structured catalysts of P6, P7, P8 and P9 are arranged so that the respective faces thereof are in contact with the anode of the SOFC cell. In such a state, when fuel gas is supplied from the paper-structured catalyst P6 side, the fuel gas is supplied along a direction parallel with the respective faces of the paper-structured catalysts of P6, P7, P8 and P9. According to such a configuration, since the temperature distribution in the reforming reaction field adjacent to the cell is made uniform, the paper-structured catalyst array body is suitable especially for direct internal reforming power generation in which a SOFC cell with a large area is used, at the time of supplying a hydrocarbon fuel such as biogas and biodiesel.

A specific example of using a paper-structured catalyst array body in which the parallel supply system is employed will be described in EXAMPLES described later.

Moreover, in the present embodiment, although a mixed gas (S/C=3.5) of a palm-BDF and steam is used as fuel gas, the present embodiment is merely illustrative of the present invention. Various hydrocarbons (for example, methane, ethane, propane, city gas, and an alcohol) may be used as the fuel hydrocarbon in place of the palm-BDF, carbon dioxide may be used as a gas for reforming, in place of steam, and the ratio of S/C may be changed. For example, in the case where the fuel hydrocarbon is methane, ethane, propane or city gas, the ratio of S/C satisfies the following expression: S/C=about 1.0 to 3.0, and in the case where the fuel hydrocarbon is an alcohol such as ethanol, the ratio of S/C satisfies the following expression: S/C=about 0.5 to 1.5.

Moreover, biogas (CH₄/CO₂=1) which is a mixed gas of methane and carbon dioxide may be used as the fuel gas. Moreover, as necessary, the ratio of CH₄/CO₂ in the fuel gas may be changed by adding CH₄ or CO₂ to the biogas, and other hydrocarbon fuels may be added thereto without causing carbon deposition.

Moreover, with regard to the reforming conditions including the gas flow rate, the temperature and the like, in view of the kind of the hydrocarbon contained in fuel gas, the ratio of S/C, and the like, preferred conditions under which the conversion ratio of the fuel gas is high and by-products (ethylene and the like) are less generated may be appropriately set.

The reforming temperature is usually about 500 to 900° C., and the contact time (W/F) is about 0.001 to 1.5 g-cat h mol⁻¹.

Hereinabove, the embodiments of the present invention are described with reference to the drawings, but these are illustrative of the present invention, and various constitutions other than the above can be employed without changing the gist of the present invention.

### EXAMPLES

The present invention will be described below in more detail with reference to examples, but the present invention should not be limited thereto.

Raw materials used

### 1. Inorganic Fibers

Stabilized zirconia (YSZ) fibers:

produced by Zircar Zirconia, Inc. (article number: ZYBF-2) diameter: 3 to 6 μm

Alumina (Al₂O₃) fibers:

produced by DENKI KAGAKU KOGYO KABUSHIKI KAISHA (article number: B100), diameter: 3 to 6 μm

Silica-alumina composite oxide (SiO₂—Al₂O₃) fibers

produced by IBIDEN CO., LTD. (IBI WOOL), diameter: 2 to 5 μm

The alumina fibers and the silica-alumina fibers were evaluated by an X-ray diffraction method, and it was confirmed that those were amorphous.

### 2. Oxide Sol (Binder)

ZrO₂ sol (produced by Nissan Chemical Industries, Ltd., article number: NanoUse ZR-30BS, pH 9.8)

Al₂O₃ sol (produced by Nissan Chemical Industries, Ltd., article number: Alumina sol 520, acidic property)

CeO₂ sol (produced by Nissan Chemical Industries, Ltd., article number: NanoUse CE-20B, pH 9.6)

### 3. Ionic Polymers

PDADMAC (polydiallyldimethylammonium chloride, Aldrich, Ltd.)

Cationic property

Molecular weight: about 3×10⁵

Charge density: 5.5 meq/g

A-PAM (anionic polyacrylamide, Kurita, Ltd.)

Anionic property

Molecular weight: about 4×10⁶

Charge density: 0.64 meq/g

### 1. Preparation of Paper-Structured Porous Support

### (1) Preparation of Paper-Structured Porous Support A

As inorganic fibers, 2 g of YSZ fibers and 3 g of alumina fibers were placed in a suitable amount of distilled water, and mixed for about 3 minutes with a mixer. Then, distilled water was added so that the solid content was 0.15 wt/vol %, and PDADMAC which was a cationic polymer was added with stirring with a stirrer so as to have a solid content of 0.25 to 1 wt % relative to the whole solid content, to positively charge the surface of inorganic fibers dispersed.

Then, oxide sol (Al₂O₃ sol), functioning as an inorganic binder after firing, was added in a solid weight of 0.5 to 2 g, and then, A-PAM which was an anionic polymer was added so as to have a solid content of 0.5 wt % relative to the whole solid content. In this connection, since the originally contained suspended material is positively charged, inorganic fibers and the like are flocculated to form ball-like floc, immediately after the anionic polymer is added. Therefore, at the time of paper-making (at the time of filtering) as a subsequent process, the filtration efficiency of water and the yield rate are enhanced.

Next, a suitable amount of commercially available pulp was defibrated and added to the slurry, and the resultant was stirred for 3 minutes. In this connection, the pulp enables to secure strength of the wet pulped substance after paper-making, and facilitates collection of a paper-structured porous support from a mesh filter before firing. Moreover, the pulp is consumed by fire during the firing of the paper-structured porous support to produce voids (diffusion paths).

The obtained slurry was poured into a commercially available paper-making apparatus (manufactured by KUMAGAI RIM KOGYO CO., LTD.), and the suspended mixture was deposited on a metal mesh filter (200-mesh) by dehydration. The formed deposit was peeled off the mesh filter, pressed for 3 minutes under a pressure of 350 kPa, and dried at 105° C. to obtain a paper-structured porous support (before firing). The diameter was about 16 cm.

The paper-structured porous support (before firing) was fired at 1300° C. under an air atmosphere for 10 hours to obtain a paper-structured porous support A (binder: Al₂O₃). An appearance photograph of the paper-structured porous support A is shown in FIG. 6.

### (2) Preparation of Paper-Structured Porous Supports B and C

A paper-structured porous support B (binder: ZrO₂) and a paper-structured porous support C (binder: CeO₂) each were obtained in the same manner as that for the paper-structured porous support A except that the oxide sol as a binder was changed from Al₂O₃ sol to ZrO₂ sol or CeO₂ sol.

### (3) Preparation of Paper-Structured Porous Support D

A paper-structured porous support D was obtained in the same manner as that for the paper-structured porous support A except that 5 g of YSZ fibers (7 mol % Y₂O₃-93 mol % ZrO₂) was used as the inorganic fibers without using alumina fibers and ZrO₂ sol was used in place of Al₂O₃ sol.

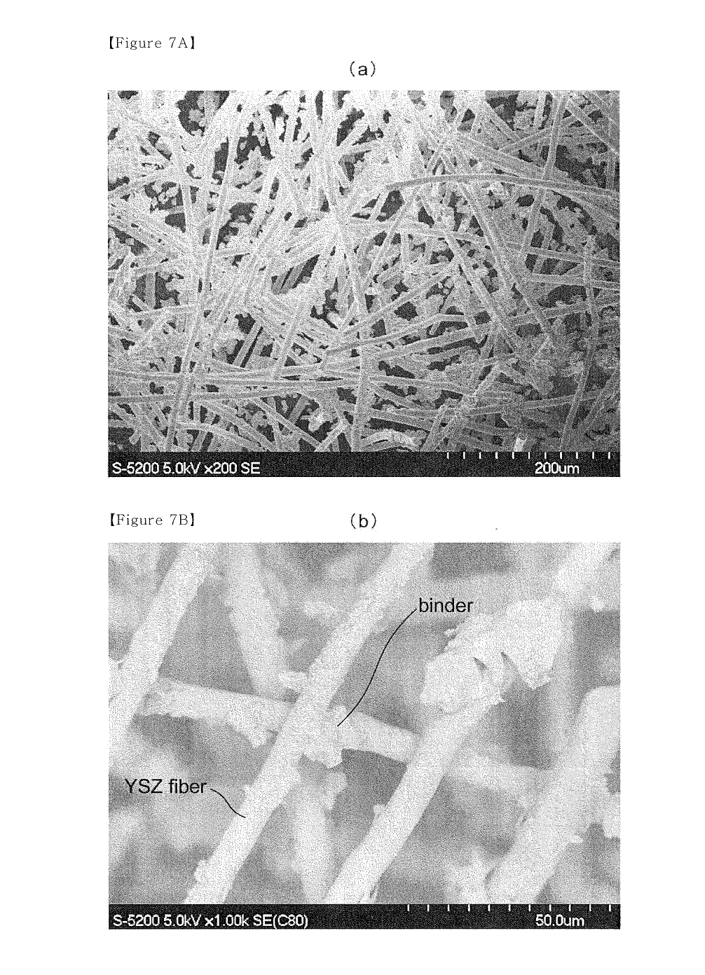

The paper-structured porous supports A to D were observed with an SEM, and it could be confirmed that the paper-structured porous support according to the present invention was a structural body provided with sufficient voids and inorganic fibers were bound by the binder component. As a typical example, SEM images of the paper-structured porous support D are shown in FIG. 7A and FIG. 7B. It has been found that YSZ fibers are in contact with each other and inorganic fibers are connected with the aid of the binder component derived from ZrO₂ sol. Moreover, even in the paper-structured porous supports A to C, a part where YSZ fibers are in contact with each other has been confirmed.

### (4) Whole Pore Volume, Porosity and Mode Diameter of Paper-Structured Porous Support

With regard to the paper-structured porous supports A to C, the measurement results of the porosity and the mode diameter by the mercury intrusion technique are shown in Table 1.

Measurement conditions: pressure range: 0.5 to 5000 psia (3.45 KPa to 34.5 MPa)

Range of pore diameter measured: about 300 μm to 37 nm

TABLE 1

| | Pore | Specific | First mode | |
|---|---|---|---|---|
| | volume | surface area | diameter | Porosity |
| | [cm³/g] | [m²/g] | [μm] | [%] |
| Paper-structured | 2.00 | 6.52 | 15.4 | 87.8 |
| porous support A | | | | |
| Paper-structured | 1.94 | 4.36 | 17.4 | 94.2 |
| porous support B | | | | |
| Paper-structured | 1.96 | 3.97 | 22.3 | 89.7 |
| porous support C | | | | |

### 2. Loading of Catalyst Metal to Paper-Structured Porous Support

### (1) Preparation of Ni-Loaded Paper-Structured Catalysts 1A to 1C

Each of the paper-structured porous supports A to C was immersed in a Ni nitrate solution of 1 mol/L, taken out after 1 hour, and dried at 105° C. for 3 hours.

Then, the paper-structured porous supports were subjected to a heat treatment at 400° C. in the atmosphere for 5 hours to obtain paper-structured catalysts 1A to 1C (before reduction) in which NiO fine particles were loaded dispersedly on the paper-structured porous supports.

### (2) Preparation of Ni—Mg Catalyst-Loaded Paper-Structured Catalyst

Each of the paper-structured porous supports A to D was immersed in a solution containing Ni nitrate in a concentration of 1 mol/L and Mg nitrate in a concentration of 1 mol/L, taken out after 1 hour, and dried at 105° C. for 3 hours.

Then, the paper-structured porous supports were subjected to a heat treatment at 800° C. for 5 hours to obtain paper-structured catalysts 2A to 2D in which NiMgO fine particles were loaded dispersedly on the paper-structured porous supports. In the paper-structured catalysts 2A to 2D, it has been confirmed that a solid solution of NiO and MgO is formed according to the evaluation of XRD. Hereinafter, catalyst metal containing Ni and Mg is designated as “Ni—Mg”.

The constitutions of paper-structured catalysts 1A to 1C and paper-structured catalysts 2A to 2D are collectively shown in Table 2.

TABLE 2

| | Kind of | Inorganic | Inorganic | |
|---|---|---|---|---|
| | Catalyst | fiber 1 | fiber 2 | Binder |
| Paper-structured | Ni | YSZ | Amorphous Al₂O₃ | Al₂O₃ |
| catalyst 1A | | | | |
| Paper-structured | Ni | YSZ | Amorphous Al₂O₃ | ZrO₂ |
| catalyst 1B | | | | |
| Paper-structured | Ni | YSZ | Amorphous Al₂O₃ | CeO₂ |
| catalyst 1C | | | | |
| Paper-structured | Ni—Mg | YSZ | Amorphous Al₂O₃ | Al₂O₃ |
| catalyst 2A | | | | |
| Paper-structured | Ni—Mg | YSZ | Amorphous Al₂O₃ | ZrO₂ |
| catalyst 2B | | | | |
| Paper-structured | Ni—Mg | YSZ | Amorphous Al₂O₃ | CeO₂ |
| catalyst 2C | | | | |
| Paper-structured | Ni—Mg | YSZ | — | ZrO₂ |
| catalyst 2D | | | | |

### 3. Evaluation

(3-1) Catalyst Surface Observation after Reduction

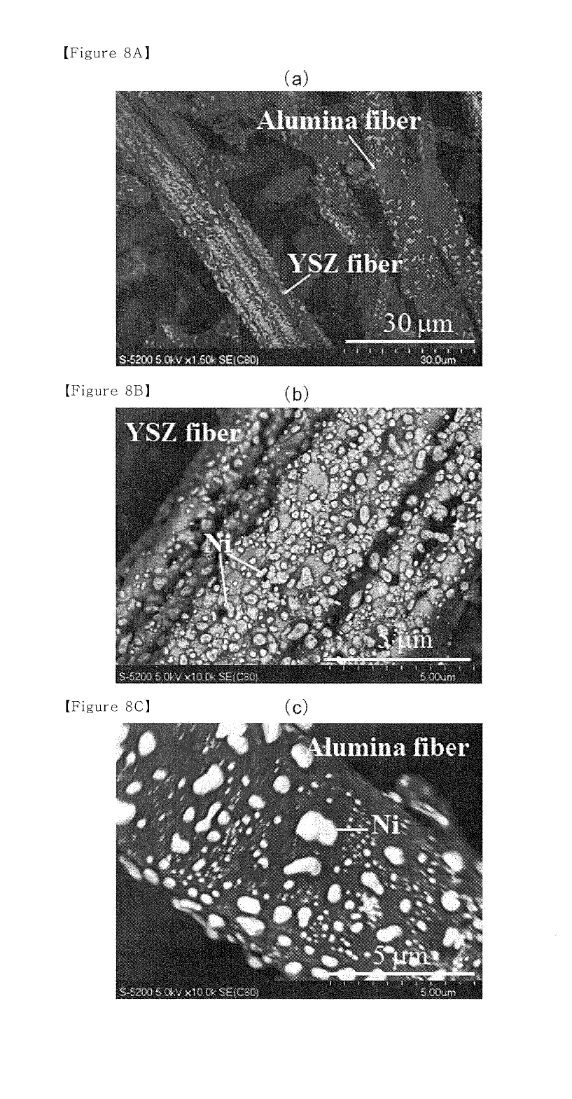

A paper-structured catalyst 1A (before reduction) was subjected to a reduction treatment at 900° C. in 5% H₂/N₂ for 1 hour. FE-SEM images of the paper-structured catalyst 1A (after reduction) are shown in FIGS. 8A to 8C. Moreover, as shown in FIG. 8B, it has been confirmed that Ni fine particles of about 100 to 500 nm are uniformly dispersed on the YSZ fiber surface.

On the other hand, as shown in FIG. 8B, coarse Ni particles were observed on the Al₂O₃ fiber surface, and the dispersibility of Ni was low as compared with the YSZ fiber surface. From this, it is considered that Ni fine particles are flocculated on the Al₂O₃ fiber surface to form coarse particles.

The structure of the paper-structured catalyst 1A (after reduction) surface photographed by a scanning probe microscope (Nanocute, manufactured by SII Nano Technology Inc.) is shown in FIG. 9A. Moreover, the structure of the paper-structured catalyst 2A (after reduction) surface subjected to the same reduction treatment is shown in FIG. 9B.

With regard to the sizes of catalyst metal particles in the paper-structured catalyst 1A (after reduction) and the paper-structured catalyst 2A (after reduction), that in the paper-structured catalyst 2A was smaller. From this, it has been suggested that microfabrication of the catalyst surface progresses by the addition of Mg.

### (3-2) Biodiesel Fuel (BDF) Steam Reforming Experiment

A reforming reaction apparatus (catalytic activity evaluation apparatus) according to the first embodiment of the present invention having a configuration shown in FIG. 3A was used to perform a steam reforming experiment of biodiesel fuel (palm-BDF (C₁₈H_{34.8}O₂)).

As the reforming experiment in Example 1, the paper-structured catalyst 1A (4) 20 mm) was superposed for two sheets and set to the reforming part shown in FIG. 3A, and H₂ was supplied to perform a reduction treatment at 900° C. for 1 hour.

Then, 50 mL/min of N₂ gas, which was an inert gas, was used as a support gas, and 6 μL/min of a BDF and 21 μL/min of distilled water in terms of the liquid volume were supplied to a vaporizer at 600° C. with a pump for liquid chromatography so that S/C was 3.5, to provide a gasified fuel gas, and the gasified fuel gas was supplied to the reforming part at 800° C. The reformed gas produced was analyzed by an automated gas chromatograph to measure the conversion ratio of the fuel and the concentration of hydrogen, carbon monoxide, carbon dioxide, methane and ethylene in the reformed gas.

Moreover, as the reforming experiments in Examples 2 to 4, the paper-structured catalysts 2A to 2C were set to the reforming part to perform the same tests.

Moreover, as the reforming experiment in Comparative Example 1, Ru/γ-Al₂O₃ catalyst beads (hereinafter, merely described as “Ru/Al₂O₃ catalyst”) as the noble catalyst metal were set to the reforming part to perform the same test. Moreover, as the reforming experiment in Comparative Example 2, pellet-like Ni/stabilized zirconia (Ni/ScSZ, Ni content: 56% by weight in terms of NiO) corresponding to a SOFC anode was used as the reforming catalyst to perform the same experiment.

The paper-structured catalysts used in the reforming experiments in Examples 1 to 4 and Comparative Examples 1 and 2 are collectively shown in Table 3.

TABLE 3

| | Kind of reforming catalyst |
|---|---|
| Example 1 | Paper-structured catalyst 1A |
| Example 2 | Paper-structured catalyst 2A |
| Example 3 | Paper-structured catalyst 2B |
| Example 4 | Paper-structured catalyst 2C |
| Comparative | Ru/Al₂O₃ catalyst |
| Example 1 | (15 catalyst beads) |
| Comparative | Ni/stabilized zirconia |
| Example 2 | (pellet-like shape) |

As shown in Table 4, various reactions such as 1. Steam reforming of BDF, 2. Pyrolysis of BDF to lower hydrocarbons, 3. Steam reforming of lower hydrocarbons, 4. Water-gas shift reaction, 5. Hydrogenation of coke, 6. Hydrogenation of CO, 7. Coke gasification, and 8. Boudouard-reaction occur, and then the BDF steam reforming reaction proceeds. In this connection, C₂H₄ as a by-product of a reforming reaction of the BDF has been known as a precursor which induces carbon deposition, and there has been a demand for reducing the production quantity as much as possible.

TABLE 4

| | | |
|---|---|---|
| 1 | CₙHₘO₂ + (n − 2)H₂O [symbol] (n + m/2 − 2)H₂ + | Steam reforming |
| | nCO | |
| 2 | CₙHₘO₂ [symbol] gases (H₂, CO, CₓH_{y}) + coke | Pyrolysis |
| 3 | CₓH_{y} + xH₂O [symbol] xCO + (x + y/2)H₂ | Steam reforming |
| 4 | CO + H₂O [symbol] H₂ + CO₂ | Water-gas shift |
| 5 | C + 2H₂ [symbol] CH₄ | Hydrogenation |
| 6 | CO + 3H₂ [symbol] CH₄ + H₂O | Hydrogenation |
| 7 | C + H₂O [symbol] CO + H₂ | Coke gasification |
| 8 | C + CO₂ [symbol] 2CO | Boudouard-reaction |

### Example 1

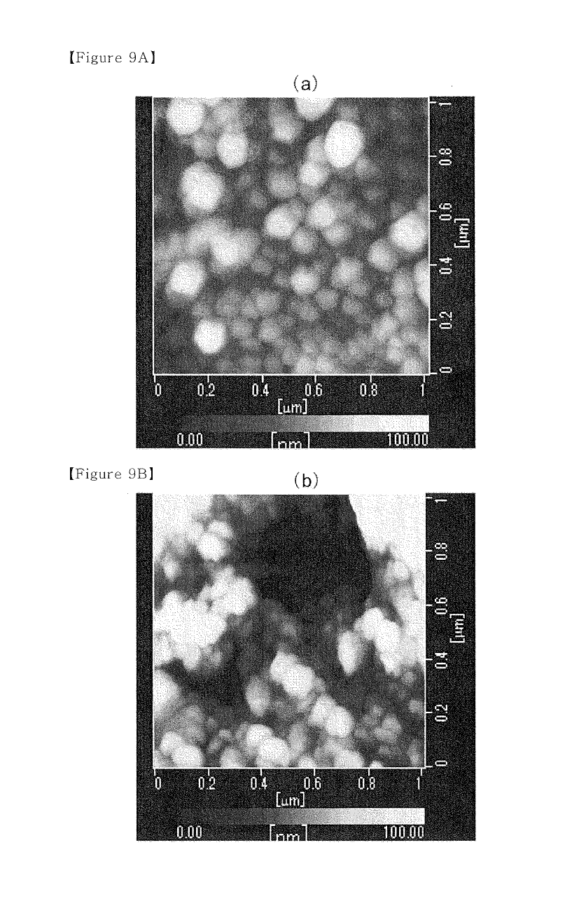

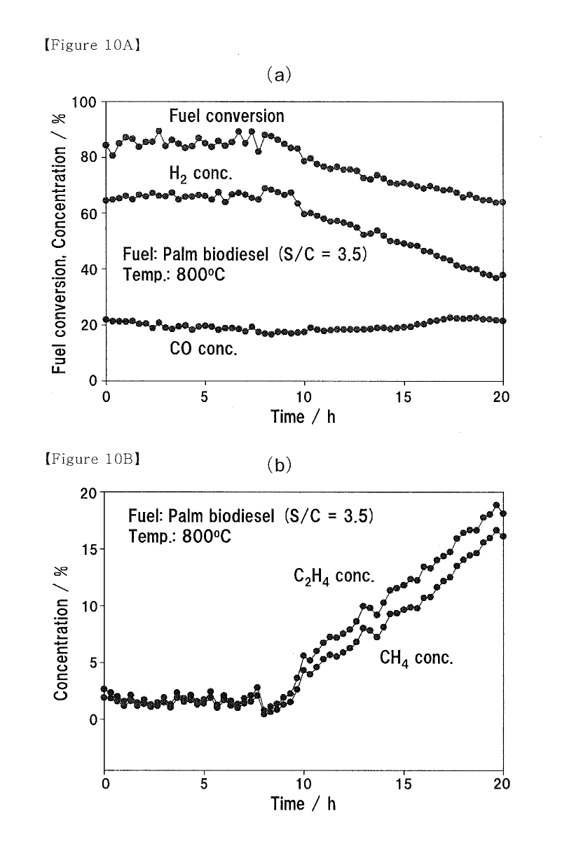

The results of a BDF steam reforming test in Example 1 are shown in FIGS. 10A and 10B.

The production quantities of CH₄ and C₂H₄ in the reformed gas were sharply increased (see FIG. 10B), and moreover, the conversion ratio of the BDF was lowered (see FIG. 10A) while the production quantities of CH₄ and C₂H₄ were sharply increased, from 8 hours after the initiation of BDF supply.

With regard to the paper-structured catalyst 1A, an FE-SEM image of the paper-structured catalyst 1A after the BDF steam reforming test for 20 hours is shown in FIG. 11.

From the result in FIG. 11, it has been found that carbon is deposited on the paper-structured catalyst 1A after the test for 20 hours. C₂H₄ has been known as a precursor which induces carbon deposition, and it is considered that carbon deposition is promoted by the increase in C₂H₄ concentration.

On the other hand, on the surface of YSZ fibers constituting the paper-structured catalyst 1A, there are a part where carbon is deposited and a part where almost no carbon is deposited. Carbon deposition is selectively detected on the Al₂O₃ binder (derived from Al₂O₃ sol) by the EDX analysis, and it is thus revealed that the use of Al₂O₃ sol induces carbon deposition.

Moreover, it has been confirmed that coarsening of Ni is progressed in the area where carbon deposition occurs.

From these results, it is revealed that the paper-structured catalyst 1A on which Ni as catalyst metal is loaded and which has an Al₂O₃ binder has high initial activity for steam reforming of the BDF, but the activity is lowered due to carbon deposition.

### Examples 2 to 4 and Comparative Example 1

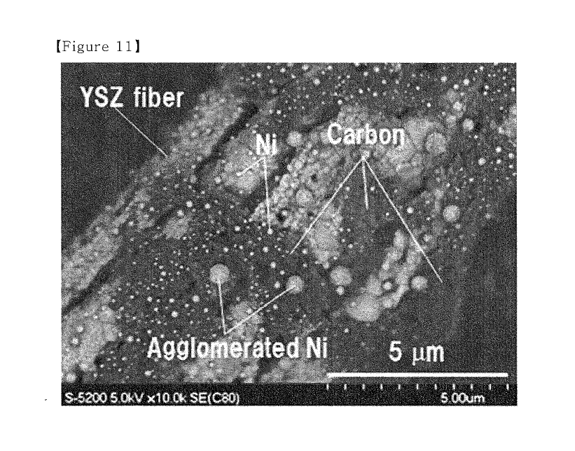

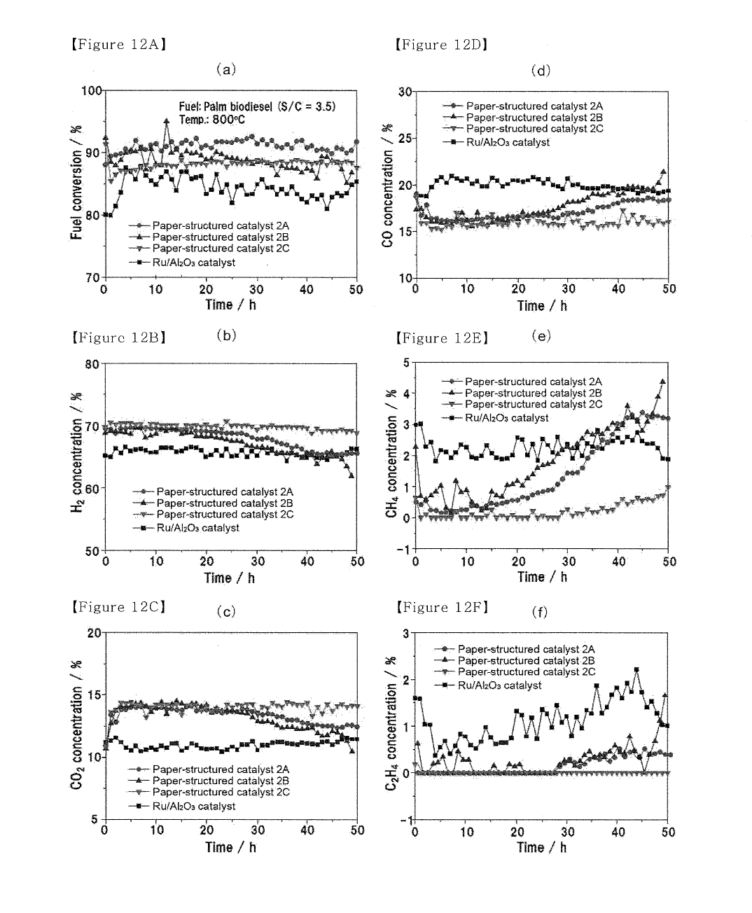

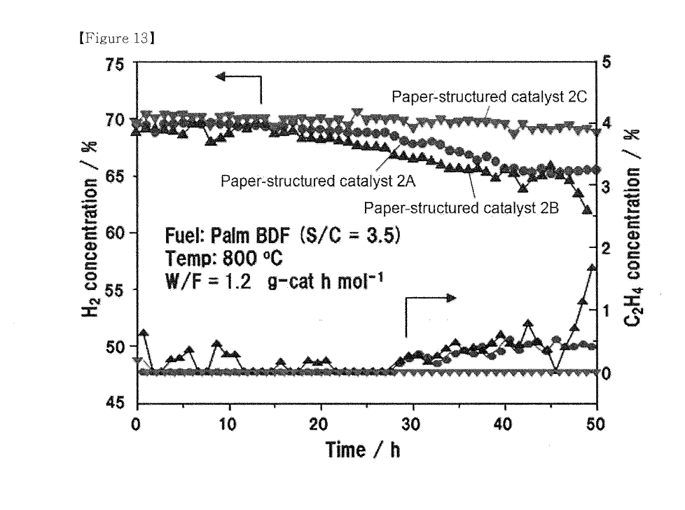

The results of steam reforming experiments (S/C=3.5) of a palm oil-BDF (C₁₈OH_{34.8}O₂) in Examples 2 to 4 (paper-structured catalysts 2A to 2C) and Comparative Example 1 are shown in FIGS. 12A to 12F. Moreover, the H₂ concentration and the C₂H₄ concentration in Examples 2 to 4 (paper-structured catalysts 2A to 2C) are collectively shown in FIG. 13.

As shown in FIG. 12A, in all of Examples 2 to 4, the BDF conversion ratios were high and the respective values close to 90% were exhibited, and each of the BDF conversion ratios was higher than that in Comparative Example 1 (Ru/Al₂O₃ catalyst). Moreover, in the paper-structured catalyst 1A on which only Ni was loaded, a large decrease in activity occurred after 8 hours (see FIG. 10A), but in Examples 2 to 4, no large decrease in activity was observed during the test for 50 hours. From these results, it has been confirmed that the paper-structured catalysts in Examples 2 to 4 in which Ni—Mg is used as the catalyst metal are excellent in BDF steam reforming performance.

As shown in FIG. 12B and FIG. 13, in all of Examples 2 to 4, each of values of the initial H₂ concentration was higher than that in the Ru/Al₂O₃ catalyst. On the other hand, with regard to Example 2 (paper-structured catalyst 2A) in which Al₂O₃ sol was used as the inorganic binder and Example 3 (paper-structured catalyst 2B) in which ZrO₂ sol was used as the inorganic binder, the H₂ concentration was gradually lowered from 20 hours. It is presumed that this is due to inhibition of the shift reaction.

On the other hand, in Example 4 (paper-structured catalyst 2C) in which CeO₂ sol was applied as the inorganic binder, the H₂ concentration was stably kept at 70% (balanced value: 71%) throughout the test. The result indicates that the CeO₂ sol added as the binder functions as a promoter and promotes the BDF steam reforming reaction.

Moreover, as apparent from FIGS. 12C and 12D, as compared with the Ru/Al₂O₃ catalyst in Comparative Example 1, in all of Examples 2 to 4, relatively high values of the CO₂ concentration was exhibited and relatively low values of the CO concentration was exhibited. This suggests that the shift reaction (CO+H₂O→CO₂+H₂) is promoted, and it is thus considered that high value of the H₂ concentration is exhibited (see FIG. 12B).

Moreover, as shown in FIGS. 12E and 12F, at the time of using the Ru/Al₂O₃ catalyst in Comparative Example 1, it was found that at most about 3% and 2% of unreacted CH₄ and C₂H₄, respectively, as the precursors which induced carbon deposition, remained in the reformed gas.

In contrast, in all of the paper-structured catalysts 2A to 2C, both CH₄ and C₂H₄ were reduced as compared with those at the time of using the Ru/Al₂O₃ catalyst. In particular, in the paper-structured catalyst 2C in which CeO₂ sol was applied as the inorganic binder, reforming of lower hydrocarbons proceeded satisfactorily and no unreacted C₂H₄ was detected during the test.

In the paper-structured catalyst 2C, with regard to CH₄ low in reactivity as compared with C₂H₄, even in the case where CeO₂ sol was used, CH₄ was detected as an unreacted component from 35 hours and the concentration was about 1% even at 50 hours.

From the above results, it has been confirmed that the BDF steam reforming in Examples 2 to 4 (paper-structured catalysts 2A to 2C) is more excellent than that in Comparative Example 1 (conventional reforming catalyst). In particular, in Ni—Mg, the activity against the BDF steam reforming with the paper-structured catalyst was considerably enhanced, and in particular, in the case of Example 4 (a paper-structured catalyst 2C) in which CeO₂ sol was used as the inorganic binder, no ethylene as a precursor for carbon deposition was produced during the test for 50 hours, and stable hydrogen production from the BDF having a high number of carbon atoms and containing a C═C bond and sulfur impurities was attained.

Moreover, similarly, with regard to the reforming performance (not illustrated) against the BDF steam reforming reaction (S/C=3.5) with a conventional pellet-like Ni-stabilized zirconia fuel electrode used in Comparative Example 2, although the fuel conversion ratio was 86% under the conditions of 800° C. and W/F=27 [g-cat h mol⁻¹] (not illustrated), with regard to the above-mentioned Ni—Mg-loaded paper catalysts (paper-structured catalysts 2A to 2C), a conversion ratio of 90% was exhibited under the condition of low W/F of W/F=1.2 [g-cat h mol⁻¹].

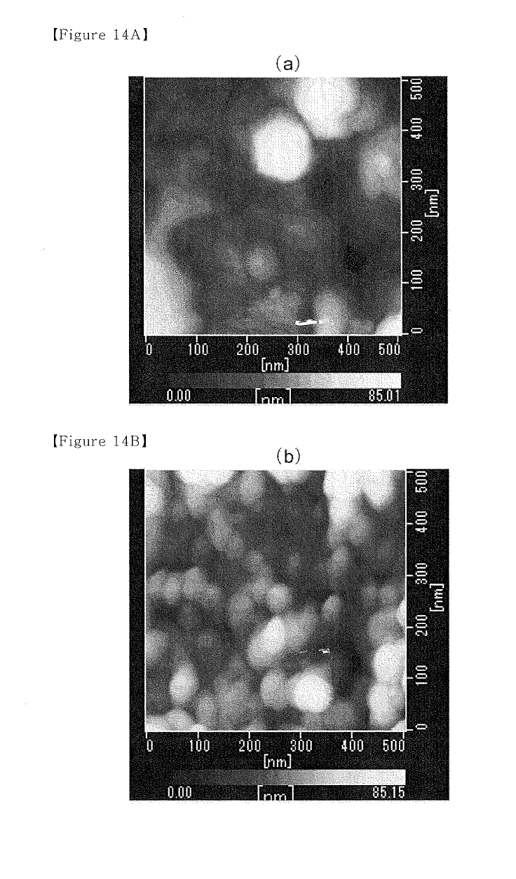

The paper-structured catalysts after the BDF steam reforming test were observed with a probe microscope. As examples of the results, images of the paper-structured catalyst 1A and the paper-structured catalyst 2A are shown in FIG. 14A and FIG. 14B, respectively.

In the case of the paper-structured catalyst 1A in which the catalyst metal was made of only Ni, the catalyst metal particle was coarse as compared with the paper-structured catalyst 2A in which the catalyst metal was made of Ni—Mg. Moreover, an image considered to be coke was also observed. In contrast, in the paper-structured catalyst 2A, even after the test, neither aggregation of catalyst metal particles nor contrast caused by coke was observed. This observation result shows that the aggregation resistance and the carbon deposition resistance are enhanced by allowing the catalyst metal to contain Mg together with Ni.

### (3-3) Methane Dry Reforming Experiment

### (1) Dependence on Amount of Catalyst Metal (Ni) Loaded in Methane Dry Reforming

As a paper-structured catalyst for Example 5, the following Ni-loaded paper-structured catalyst 1E was produced, and the paper-structured catalyst was evaluated for the dependence on the amount of the catalyst metal (Ni) loaded in the reforming of a simulated biogas as the methane dry reforming.

### Preparation of Paper-Structured Catalyst 1E

Paper-structured catalysts differing in the amount of Ni loaded (collectively described as “paper-structured catalysts 1E”) were prepared in the following manner.

First, a paper-structured porous support E was prepared by the same production method as that for the above-mentioned paper-structured porous support A except that an equal weight of alumina-silica fibers (produced by IBIDEN CO., LTD., IBI WOOL) was used in place of the alumina fibers, ZrO₂ sol was used as the binder in place of the Al₂O₃ sol, and the firing conditions were set to 800° C. and 5 hours.

The paper-structured porous support E was immersed in a Ni nitrate solution of a suitable concentration, taken out after 1 hour, and dried at 105° C. for 3 hours. Then, the paper-structured porous support was subjected to a heat treatment at 400° C. in the atmosphere for 5 hours to obtain a paper-structured catalyst 1E (before reduction) in which NiO fine particles in an amount of 0.1 to 25% by weight in terms of Ni were loaded dispersedly on the paper-structured porous support E.

Each of the paper-structured catalysts 1E (before reduction) differing in the amount of Ni loaded was subjected to a reduction treatment at 800° C. in H₂ for 1 hour to reduce NiO to Ni, after which a simulated biogas was supplied under the conditions of 800° C., 20 mL/minute of CH₄, 20 mL/minute of CO₂, and 20 mL/minute of N₂ (CH₄/CO₂=1) to evaluate the reforming activity.

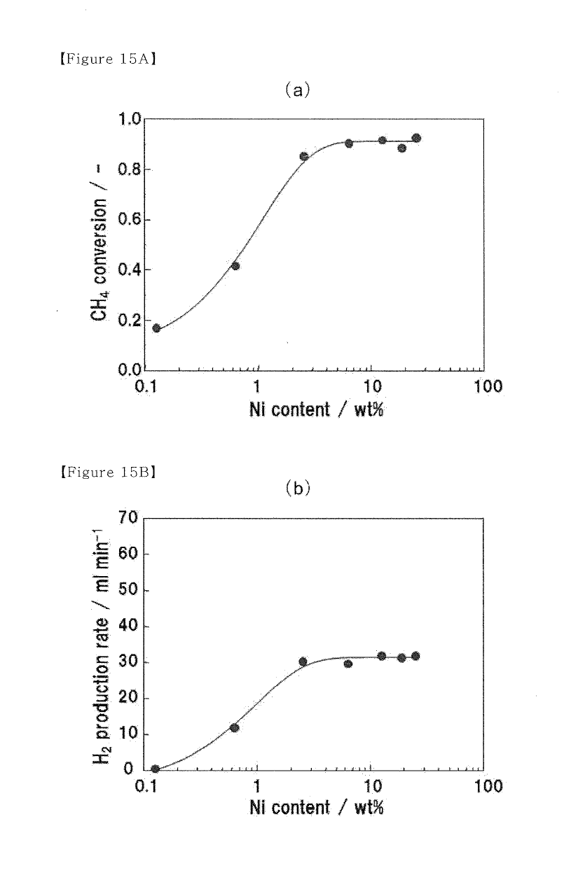

Graphs representing the results of methane conversion ratio and hydrogen production rate are shown in FIG. 15A and FIG. 15B, respectively. The methane conversion ratio and the hydrogen production rate were increased as the amount of Ni loaded was larger, and the methane conversion ratio and the hydrogen production rate were almost constant when the amount of Ni loaded was within the range of 3% by weight or more. Moreover, since the number of aggregated particles was increased when the amount of Ni loaded exceeded 20% by weight, a preferred range of the amount of Ni loaded was determined to be 1% by weight to 20% by weight.

(2) Contrast with Conventional Reforming Catalyst

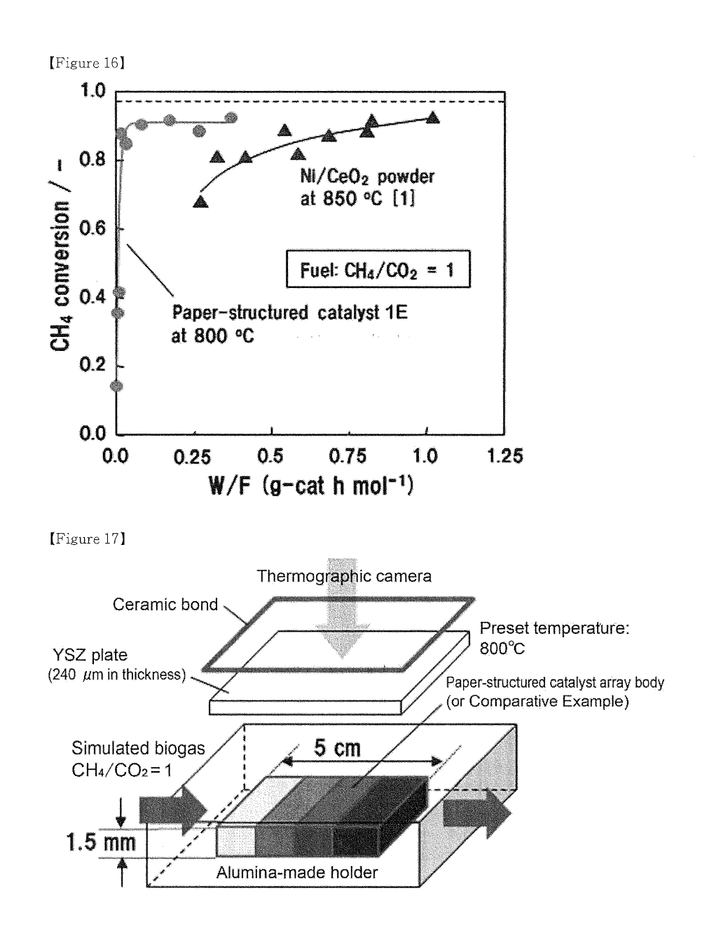

Paper-structured catalysts 1E in Example 5 were evaluated for the methane dry reforming performance. The W/F [g-cat h mol⁻¹] dependence of the methane conversion ratio at the time of methane dry reforming (CH₄/CO₂=1, 800° C.) is shown in FIG. 16. Moreover, as a reference example of a conventional reforming catalyst, data (reforming temperature: 850° C.) obtained by means of a Ni/CeO₂ powder catalyst disclosed in a prior art document (Asami K, Lia X, Fujimoto K, Koyama Y, Sakurama A, Kometani N, CO₂ reforming of CH₄ over ceria-supported catalyst metals. Catal Today 2003; 84: 27-31.) is shown in FIG. 16 together therewith.

In Example 5 (paper-structured catalysts 1E), a methane conversion ratio of 91% was exhibited at 800° C. within the area of a low W/F value of W/F=0.08 [g-cat h mol⁻¹]. That is, in Example 5, a methane conversion ratio equivalent to that of the Ni/CeO₂ powder catalyst as the reference example can be attained under the conditions of a low temperature of 50° C. and about one-twelfth of the catalyst weight. Moreover, as a comparative example, with regard to the reforming performance (not illustrated) against the methane dry reforming reaction with a pellet-like Ni-stabilized zirconia fuel electrode (Ni-YSZ, Ni content: 56% by weight in terms of NiO), the methane conversion ratio was 74% under the conditions of 800° C. and W/F=8.4 [g-cat h mol⁻¹].

That is, it has been found that the catalysts in Example 5 (paper-structured catalysts 1E) have more excellent reforming performance against methane dry reforming than the conventional powdered catalyst. This is because, as schematically shown in FIG. 1, the spatial structure formed by an inorganic fiber network and having a high degree of freedom promotes three-dimensional diffusion of a gas, and the contact efficiency between fuel gas and metal fine particles loaded catalyst is extremely improved.

### (3-4) Reforming of Biogas by Means of Paper-Structured Catalyst Array Body (Temperature Distribution Evaluation)

A reforming reaction apparatus with a configuration shown in FIG. 17 (hereinafter, sometimes described as “planar type reformer”) was used to perform a reforming test of a simulated biogas (CH₄/CO₂=1)

### (1) Preparation of Paper-Structured Catalyst Array Body

Paper-structured catalysts P6 to P9 (1.25×5 cm, thickness: 1.5 mm) constituting a paper-structured catalyst array body as an example are those in which Ni or Ni—Mg is loaded on the paper-structured porous support F, prepared by the following procedure, in the same manner as the production method of the above-mentioned paper-structured catalysts 1A and 2A according to the impregnation method. The kind of the catalyst, the amount of Ni loaded, and the Ni/Mg (atomic ratio) in each of the paper-structured catalysts P6 to P9 are collectively shown in Table 5.

### (Preparation of Paper-Structured Porous Support F)

A paper-structured porous support F was prepared by the same production method as that for the above-mentioned paper-structured porous support A except that alumina-silica fibers (produced by IBIDEN CO., LTD., IBI WOOL) were used in place of the alumina fibers, ZrO₂ sol was used as the binder in place of the Al₂O₃ sol, and the firing conditions were set to 800° C. and 5 hours.

TABLE 5

| Paper-structured | Kind of | Amount of Ni loaded | Ni/Mg |
|---|---|---|---|
| catalyst | catalyst | (% by weight) | (atomic ratio) |
| P6 | Ni | 0.30 | — |
| P7 | Ni | 0.49 | — |
| P8 | Ni—Mg | 0.76 | 0.2 |
| P9 | Ni—Mg | 3.8 | 0.5 |

The paper-structured catalysts P6 to P9 were arranged in a plane in this order to obtain a catalytically functionally-graded paper-structured catalyst array body (5×5 cm) as an example. In this connection, Ni—Mg was used in P8 and P9 in order to suppress carbon deposition significant with the increase in amount of Ni loaded.

Moreover, as a comparative example, a paper-structured catalyst (5×5 cm) in which Ni was loaded (functionally not graded) on the paper-structured porous support F (5×5 cm, thickness: 1.5 mm) so as to have an amount of Ni loaded of 3.8% by weight was used.

### (2) Evaluation for Temperature Distribution in Paper-Structured Catalyst Array Body

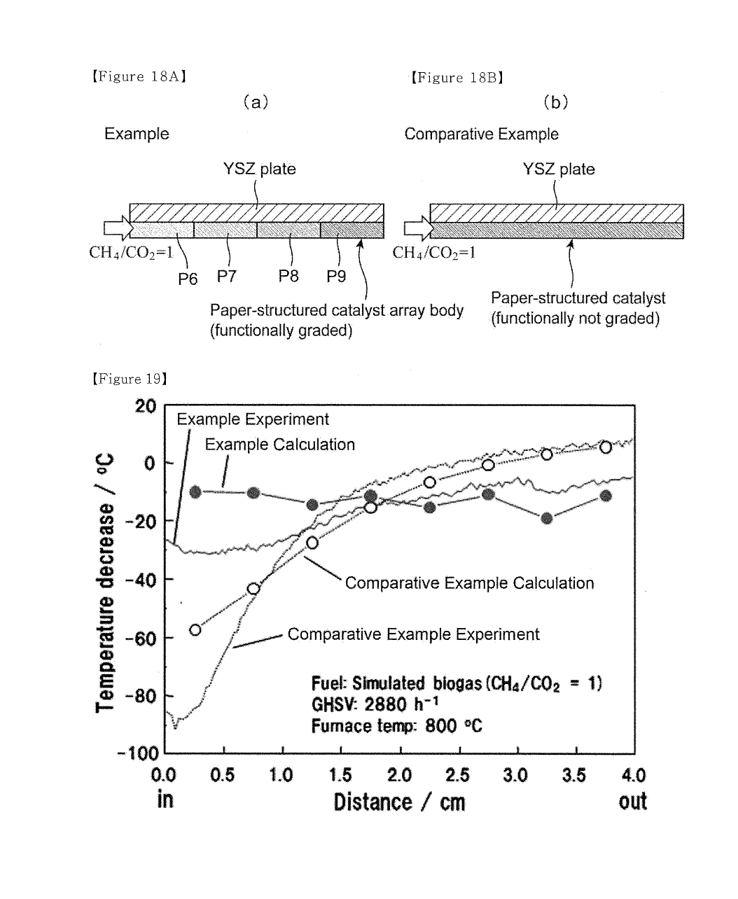

Each of the prepared paper-structured catalyst array body as an example (functionally graded) and the paper-structured catalyst as a comparative example (functionally not graded) was arranged as shown in FIG. 17, and an experiment for evaluating the temperature distribution in the paper-structured catalyst array body (within 4 cm×4 cm) was performed using a reactor (planar type reformer) sealed with a YSZ plate. Schematic cross-sectional views of the paper-structured catalyst array body as an example arranged in the planar type reformer and the paper-structured catalyst as a comparative example are shown in FIGS. 18A and 18B, respectively.

The temperature distribution in the gas flow direction at the time of supplying a simulated biogas to the paper-structured catalyst array body as an example from the P6 side to the P9 side under the conditions of 800° C. and GHSV=2880 h⁻¹ is shown in FIG. 19. The horizontal axis in the drawing indicates the distance from the gas inlet side when a position spaced 0.5 mm apart from the left end of the paper-structured catalyst array body is set to 0, and the vertical axis indicates the decrease in temperature due to the reforming reaction. Moreover, the paper-structured catalyst as a comparative example, having the same size as that of the paper-structured catalyst array body as an example (functionally graded), was evaluated in the same manner. The result is shown in FIG. 19.

In both cases of the example and the comparative example, the CH₄ conversion ratio was 91%, and the reaction proceeded until the CH₄ conversion ratio reached around the conversion ratio (97%) calculated from the equilibrium theory. On the other hand, while the maximum temperature gradient in the paper-structured catalyst as a comparative example was 86 Kcm⁻¹, the maximum temperature gradient generated in the paper-structured catalyst array body as an example was reduced to 19 Kcm⁻¹.

That is, it has been shown that an array of paper-structured catalysts in the paper-structured catalyst array body can be optimized to thereby suppress the generation of temperature gradient in the planar type reactor without lowering the conversion ratio.

### (3) Durability Evaluation

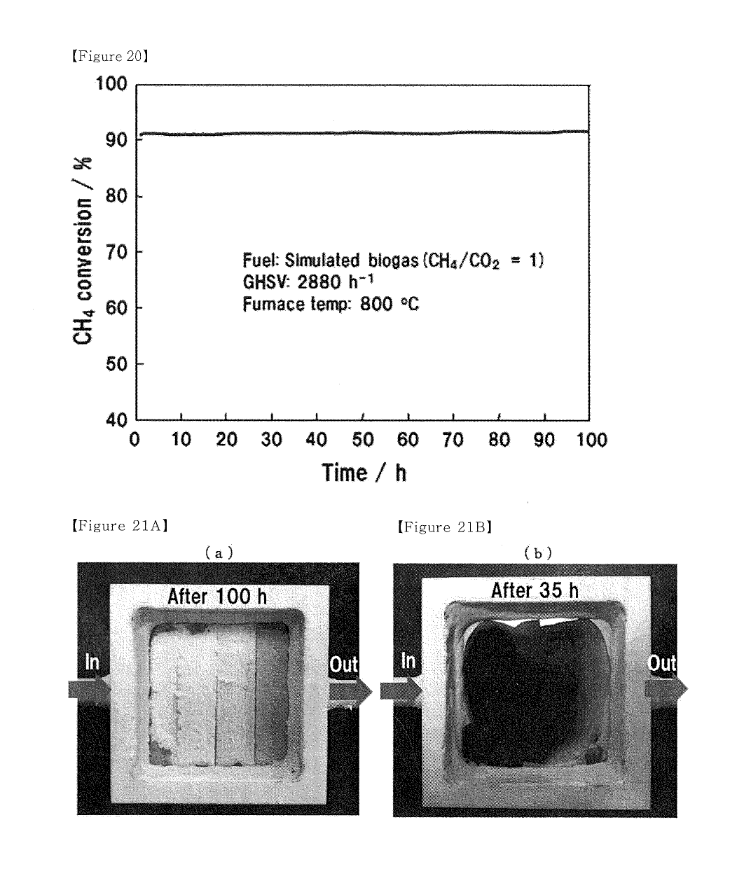

A dry reforming test of methane was performed for 100 hours using a paper-structured catalyst array body as an example in the planar type reactor shown in FIG. 17. The result is shown in FIG. 20. As shown in the drawing, the reforming was stably performed for 100 hours, and during the test, the YSZ plate with a thickness of 240 μm, arranged adjacent to the reforming reaction field as a separator separating fuel and air from each other, was not broken. Moreover, after the test, the YSZ plate was removed to observe the paper-structured catalyst array body, and carbon deposition did not occur (see FIG. 21A).

On the other hand, the paper-structured catalyst as a comparative example in which the catalyst was uniformly loaded was evaluated in the same manner, and thermal stress was generated due to a significant temperature drop at the fuel inlet side and a crack was generated in the YSZ plate after 35 hours. Furthermore, with this temperature drop, an environment in which carbon deposition thermodynamically easily occurred was formed, and production of carbon was remarkably observed (see FIG. 21B).

It has been shown that by means of the paper-structured catalyst array body as an example thus catalytically-graded, hydrogen and carbon monoxide can be stably produced for a long period of time, and the paper-structured catalyst array body greatly contributes to the tolerance of mechanical degradation and destruction of a YSZ plate adjacent thereto.

### (3-5) Evaluation by Means of SOFC

### (3-5-1) Internal Reforming SOFC

(1) Preparation of Electrolyte-Supported Type SOFC Provided with Paper-Structured Catalyst Array Body

NiO-YSZ (NiO: 56% by weight) was used as an anode material, La_{0.8}Sr_{0.2}MnO_{3-δ} (LSM) and YSZ (LSM: 50% by weight) were used as cathode materials, and a YSZ plate (5×5 cm, thickness: 240 μm) was used as an electrolyte.

The anode material and the cathode material were respectively applied to front and back surfaces of 4×4 cm of the YSZ plate by screen printing and fired under prescribed conditions (anode: 1300° C., 3 hours, cathode: 1200° C., 5 hours) to obtain an electrolyte-supported type SOFC.

A paper-structured catalyst array body having such a configuration shown in FIG. 22A was arranged at the anode side of the electrolyte-supported type SOFC so as to be in contact with the anode, to obtain an internal reforming SOFC as an example.

This paper-structured catalyst array body and the paper-structured catalyst array body described in the above-mentioned (3-4) (1) are the same as each other.

Moreover, as a comparative example, a paper-structured catalyst having such a configuration shown in FIG. 22B was arranged so as to be in contact with the anode, to obtain an internal reforming SOFC as a comparative example. The paper-structured catalyst used in a comparative example has the same size as that of the paper-structured catalyst array body used in an example.

### (2) Test for Long-Term Stability at the Time of Supplying Simulated Biogas

An internal reforming SOFC system with a configuration shown in FIGS. 22A and 22B was used to perform a power generation experiment in which a simulated biogas was employed as fuel gas. The fuel gas was supplied from the P6 side.

First, H₂ was supplied and the paper-structured catalyst was subjected to a reduction treatment at 800° C. for 1 hour. Then, the simulated biogas was supplied under the following conditions to perform reforming of the fuel gas and power generation, and the voltage degradation rate was evaluated under a constant current density of 100 mA·cm⁻².

### (Power Generation Conditions)

Fuel gas: biogas: (CH₄+CO₂), CH₄/CO₂=1

Anode side flow rate: CH₄: 90 mL/min, CO₂: 90 mL/min

Cathode side: exposed to the air in the electric furnace

Measurement temperature: 800° C.

Current density: 100 mA·cm⁻²

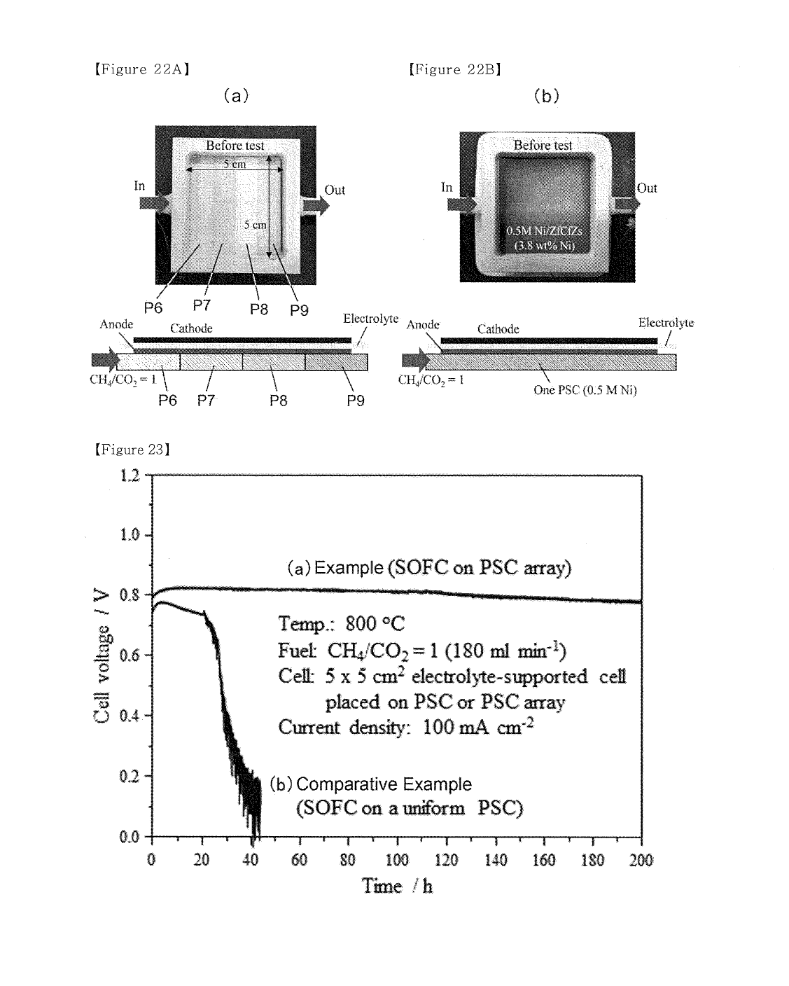

As shown in FIG. 23, in an internal reforming SOFC as a comparative example, the voltage was significantly lowered from about 20 hours after the initiation of the test, and the internal reforming SOFC could not generate power at about 40 hours. The paper-structured catalyst structural body after the test was observed, and the deposition of a large amount of carbon was confirmed.

In contrast, in an internal reforming SOFC as an example provided with a catalytically-graded paper-structured catalyst array body, the voltage was stable, and after the test, no carbon deposition was observed in the paper-structured catalyst array body.

Moreover, a paper-structured catalyst array body as an example was adjacently arranged at the anode side of an anode-supported type cell of 5 cm square, a long-term stability test under a constant current density of 200 mA·cm⁻² was performed in the same manner, and a voltage degradation rate of 1.7%/1000 hours was achieved. Moreover, after the test for 600 hours, no carbon deposition was observed at the anode side where the paper-structured catalyst array body was layered.

From the above results, it has been confirmed that the internal reforming SOFC as an example in which the paper-structured catalyst is arranged adjacent to the anode is capable of stably generating power with high output even when a simulated biogas is employed as fuel gas to perform power generation as compared with the conventional SOFC.

### (3-5-2) Evaluation by Means of External Reforming SOFC

### (1) Preparation of Anode-Supported Type SOFC

A perovskite type cathode paste and a cathode collector paste, and an anode collector paste were screen-printed on an electrolyte side surface and an anode side surface of a button type anode-supported type half-cell (anode-support (NiO:YSZ=5.6:4.4), thickness: 0.8 mm, diameter: 20 mm, YSZ electrolyte thickness: 8 μm, manufactured by Saga Ceramic Research Laboratory), respectively, and fired at 900° C. for 5 hours to prepare an anode-supported type button cell.

### (2) Power Generation Experiment

An external reforming SOFC system with a configuration shown in FIG. 3B was used to perform a power generation experiment in which a simulated biogas or a simulated BDF was employed as fuel gas.

### (2-1) Power Generation by Means of Simulated Biogas

A paper-structured catalyst 2E (φ20 mm) for simulated biogas power generation evaluation was prepared by the same production method as that for the paper-structured catalyst 1E described in the above-mentioned (3-3) (1) except that catalyst-loading was performed by immersion in a solution containing Ni nitrate in a concentration of 0.1 mol/L and Mg nitrate in a concentration of 1.0 mol/L. The configuration of a paper-structured catalyst 2E is shown in Table 6.

The paper-structured catalyst 2E was superposed for two sheets and set to the reforming part in a reforming reaction apparatus 10a shown in FIG. 3B, and the above-mentioned anode-supported type button cell was set to a SOFC system 10b.

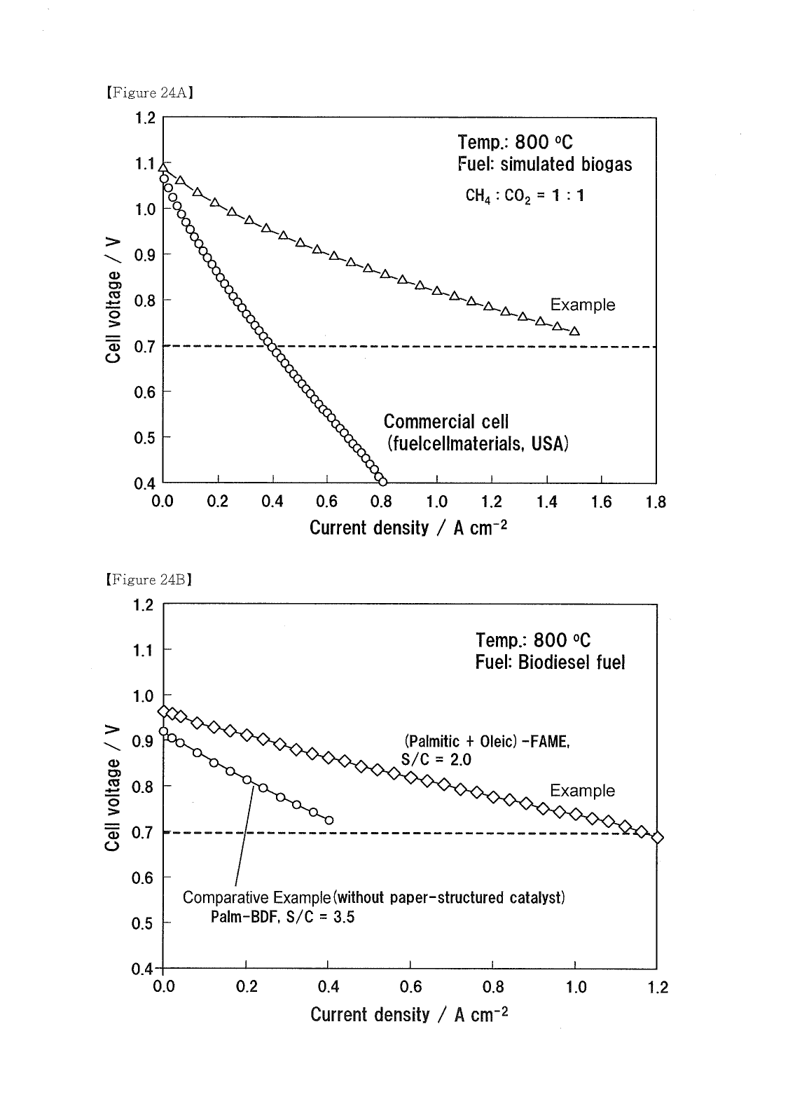

First, H₂ was supplied to the reforming reaction apparatus 10a and the paper-structured catalyst was subjected to a reduction treatment at 800° C. for 15 hours. Then, the simulated biogas was supplied to the reforming reaction apparatus 10a under the following power generation conditions to perform reforming of the fuel gas, and a gas after reforming was supplied to the SOFC system 10b arranged at the subsequent stage to evaluate current voltage characteristics. Moreover, as a comparative example, a power generation test was performed in the same manner without using the paper catalyst in the reforming reaction apparatus 10a. The results of the power generation test by means of a simulated biogas are shown in FIG. 24A.

### (Power Generation Conditions)

Fuel gas: biogas: (CH₄+CO₂), CH₄/CO₂=1

Anode side flow rate: CH₄: 20 mL/min, CO₂: 20 mL/min

Cathode side flow rate: Air: 150 mL/min

Measurement temperature: 800° C.

As shown in FIG. 24A, in the case where the simulated biogas was supplied at 800° C. and at a cell voltage of 0.7 V, the current density was 0.4 Acm⁻² in the SOFC as a comparative example, and the current density was 1.6 Acm⁻² in the SOFC as an example. Furthermore, in the SOFC as an example, in the case where the simulated biogas was supplied at 750° C., a high current density of 1.2 Acm^{e} was attained and a value of power generation efficiency of 45% LHV (at Uf=78%) was achieved.

### (2-2) Power Generation by Means of Simulated BDF

As paper-structured catalysts for simulated BDF power generation evaluation, a paper-structured catalyst 3E and a paper-structured catalyst 1G were prepared.

The paper-structured catalyst 3E (φ20 mm) was prepared by the same production method as that for the paper-structured catalyst 1E described in the above-mentioned (3-3) (1) except that catalyst-loading was performed by immersion in a solution containing Ni nitrate in a concentration of 1.0 mol/L and Mg nitrate in a concentration of 1.0 mol/L.

The paper-structured catalyst 1G (φ20 mm) was prepared by the same production method as that for the paper-structured catalyst 1E described in the above-mentioned (3-3) (1) except that a BaTiO₃ powder was used in place of the YSZ fibers and catalyst-loading was performed by immersion in a 1.0 mol/L ruthenium chloride solution. The configurations of paper-structured catalysts 3E and 1G are collectively shown in Table 6.

The paper-structured catalyst 1G and the paper-structured catalyst 3E were superposed and set at the first tier (fuel inlet side) and the second tier (SOFC side), respectively, in the reforming part in a reforming reaction apparatus 10a shown in FIG. 3B, and the above-mentioned anode-supported type button cell was set to a SOFC system 10b.

First, H₂ was supplied to the reforming reaction apparatus 10a and the paper-structured catalyst was subjected to a reduction treatment at 800° C. for 5 hours. Then, the simulated BDF was supplied to the reforming reaction apparatus 10a under the following power generation conditions to perform reforming of the fuel gas, and a gas after reforming was supplied to the SOFC system 10b arranged at the subsequent stage to evaluate current voltage characteristics. Moreover, as a reference example, a power generation test was performed in the same manner without using the paper catalyst in the reforming reaction apparatus 10a. The results of the power generation test by means of a simulated BDF are shown in FIG. 24B.

### (Power Generation Conditions)

Fuel gas: simulated BDF: a 1:1 mixed liquid of palmitic acid methyl ester (C₁₇H₃₄O₂) and oleic acid methyl ester (C₁₉H₃₆O₂)

Amount of steam added (S/C): 2.0

Anode side flow rate (liquid flow rate): simulated BDF: 6 μL/min, water: 12 μL/min

Cathode side flow rate: Air: 150 mL/min

Measurement temperature: 800° C.

As shown in FIG. 24B, in the case where the humidified simulated BDF prepared by mixing palmitic acid methyl ester (C₁₇H₃₄O₂) and oleic acid methyl ester (C₁₉H₃₆O₂), which were main components of palm oil, at a ratio of 1:1 was supplied (S/C=2.0), the current density was 0.4 Acm⁻² in the SOFC as a comparative example and the current density was 1.2 Acm^{e} in the SOFC as an example when the cell voltage was 0.7 V.

From the above results, it has been confirmed that the external reforming SOFC system as an example in which the paper-structured catalyst according to the present invention is used for an external reformer is capable of stably generating power with high output even when a hydrocarbon-containing fuel gas such as a simulated biogas and a simulated BDF is used to perform power generation.

TABLE 6

| | | | | | Amount of Ni | Ni/Mg |
|---|---|---|---|---|---|---|
| | Kind of | Inorganic | | | loaded | (atomic |
| | catalyst | fiber 1 | Inorganic fiber 2 | Binder | (% by weight) | ratio) |
| Paper-structured catalyst 2E | Ni—Mg | YSZ | Amorphous SiO₂—Al₂O₃ | ZrO₂ | 0.76 | 0.1 |
| Paper-structured catalyst 3E | Ni—Mg | YSZ | Amorphous SiO₂—Al₂O₃ | ZrO₂ | 7.6 | 1 |
| Paper-structured catalyst 1G | Ru | BaTiO₃ | Amorphous SiO₂—Al₂O₃ | ZrO₂ | — | — |
| | | (Powder) | | | | |

### INDUSTRIAL APPLICABILITY

Since the paper-structured catalyst according to the present invention has high reforming activity against hydrocarbons, is strong against thermal stress fracture, is easily moldable into a prescribed size/shape, and has high degree of freedom at the time of catalyst arranging, it is easy to achieve much high-performance/downsizing of a reformer. Moreover, since a paper-structured catalyst array body prepared by arranging multiple sheets of the paper-structured catalyst is hardly susceptible to destruction of the catalyst structure and the adjacent material due to thermal shock, reforming of hydrocarbons can be more stably performed. Moreover, since an internal reforming solid oxide fuel cell prepared with the paper-structured catalyst or the paper-structured catalyst array body according to the present invention as a hydrocarbon reforming catalyst can suppress thermal stress fracture and degradation due to carbon deposition, power generation can be more stably performed.

1. A paper-structured catalyst, comprising a paper-structured porous support prepared by forming inorganic fibers in a paper-like shape, and catalyst metal which is loaded dispersedly on a surface of the paper-structured porous support and has reforming activity against hydrocarbons, wherein the inorganic fibers constituting the paper-structured porous support contain at least partially ion conductive oxide fibers.

2. The paper-structured catalyst according to claim 1, wherein the ion conductive oxide fibers are at least partially in contact with each other in the paper-structured porous support.

3. The paper-structured catalyst according to claim 1, wherein a proportion of the ion conductive oxide fibers relative to the whole inorganic fibers constituting the paper-structured porous support is 10% by weight or more.

4. The paper-structured catalyst according to claim 1, wherein a part of the ion conductive oxide fibers are stabilized zirconia fibers.

5. The paper-structured catalyst according to claim 1, wherein the paper-structured porous support includes alumina fibers or alumina-silica composite oxide fibers.

6. The paper-structured catalyst according to claim 1, wherein the inorganic fibers constituting the paper-structured porous support are substantially made of ion conductive oxide fibers.

7. The paper-structured catalyst according to claim 6, wherein the ion conductive oxide fibers are stabilized zirconia fibers.

8. The paper-structured catalyst according to claim 1, wherein the paper-structured porous support is formed by binding the inorganic fibers by a binder containing CeO₂.

9. The paper-structured catalyst according to claim 1, wherein a porosity of the paper-structured porous support is 75% by volume or more and 95% by volume or less.

10. The paper-structured catalyst according to claim 1, wherein the catalyst metal is catalyst metal containing Ni and Mg.

11. A paper-structured catalyst array body prepared by arranging multiple sheets of the paper-structured catalyst according to claim 1, wherein the multiple sheets are arranged in order from a paper-structured catalyst having a lower reforming performance against hydrocarbons to a paper-structured catalyst having a higher reforming performance against hydrocarbons.

12. The paper-structured catalyst array body according to claim 11, wherein an array of sheets of the paper-structured catalyst is a planar array.

13. A reforming method of hydrocarbons, comprising supplying a fuel gas mixture containing hydrocarbons and steam or carbon dioxide from the side of the paper-structured catalyst having a lower reforming performance against hydrocarbons in the paper-structured catalyst array body according to claim 11, to sequentially reform the hydrocarbons in the fuel gas mixture by means of the paper-structured catalysts constituting the paper-structured catalyst array body.

14. The reforming method of hydrocarbons according to claim 13, wherein hydrocarbon in the fuel gas mixture is biogas or biodiesel.

15. A solid oxide fuel cell, comprising a solid electrolyte, an anode arranged on one face of the solid electrolyte, and a cathode arranged on the other face of the solid electrolyte, wherein the paper-structured catalyst according to claim 1 is placed before the anode.

16. The solid oxide fuel cell according to claim 15, wherein the paper-structured catalyst is arranged on the anode.

17. The solid oxide fuel cell according to claim 15, wherein the solid electrolyte is made of the same ion conductive oxide as that of the ion conductive oxide fibers constituting the paper-structured porous support in the paper-structured catalyst.

18. The solid oxide fuel cell according to claim 15, wherein the fuel gas is biogas or biodiesel.

19. A solid oxide fuel cell, comprising a solid electrolyte, an anode arranged on one face of the solid electrolyte, and a cathode arranged on the other face of the solid electrolyte, wherein the paper-structured catalyst array body according to claim 11 is placed before the anode.

20. The solid oxide fuel cell according to claim 19, wherein the paper-structured catalyst array body is arranged on the anode.

21. The solid oxide fuel cell according to claim 19, wherein the solid electrolyte is made of the same ion conductive oxide as that of the ion conductive oxide fibers constituting the paper-structured porous support in the paper-structured catalyst array body.

22. The solid oxide fuel cell according to claim 19, wherein the fuel gas is biogas or biodiesel.
